(19) United States
(12) Patent Application Publication
(10) Pub. No.: US 2023/0231764 A1
(43) Pub. Date: Jul. 20, 2023

(54) APPARATUSES, COMPUTER-IMPLEMENTED METHODS, AND COMPUTER PROGRAM PRODUCTS FOR IMPROVED SELECTION AND PROVISION OF OPERATIONAL SUPPORT DATA OBJECTS

(71) Applicant: Assurant, Inc., New York, NY (US)

(72) Inventors: Mircea IONESCU, Wooster, OH (US); Patrick Scott MCLAUGHLIN, Westlake, OH (US); Karni JASROTIA, Westlake, OH (US)

(21) Appl. No.: 17/692,919

(22) Filed: Mar. 11, 2022

Related U.S. Application Data
(60) Provisional application No. 63/266,222, filed on Dec. 30, 2021.

(51) Int. Cl. H04L 41/0677; H04L 41/0604; G06Q 30/00; H04L 12/28

(52) U.S. Cl. CPC H04L 41/0677; G06Q 30/016; H04L 12/2803; H04L 41/0613

(57) ABSTRACT

Embodiments of the present disclosure provide for predicted operational support data object selection and provision functionality. Predicted operational support data object(s) may be selected and provided to address particular malfunction classification(s) affecting networked device(s) on a dynamic home communications network. Some embodiments include identifying, in real-time, a device identification data set associated with a networked device set communicable with the dynamic home communications network; retrieving a device activity data set associated with the networked device set; applying a malfunction classification data model to the device activity data set to select the predicted operational support data object from the device operational support management repository; and outputting the predicted operational support data object to a client device in communication with the dynamic home communications network. The malfunction classification data model is trained based on training data, external aggregated activity data, and malfunction device history data.

### CROSS-REFERENCE TO RELATED APPLICATIONS

This application claims priority to U.S. Provisional Pat. Application No. 63/266,222 filed Dec. 30, 2021, the contents of which are incorporated by reference herein in their entirety.

### TECHNOLOGICAL FIELD

Embodiments of the present disclosure generally relate to automatically providing operational support data object(s) that may assist in resolving malfunction(s) for one or more device(s), and specifically to applying at least device activity data, and optionally external aggregated device activity data and malfunction device history data, to a malfunction classification data model to select at least a predicted operational support data object for outputting via a client device.

### BACKGROUND

For any of a myriad of reasons, devices, systems, networks, and/or other configuration of computing devices may experience any number of technical problems affecting their operation. Such problems may include decreased performance, crashes, lack of connectivity, software bugs, and the like. Users of such devices, or associated with such devices, may seek resources, methods, processes, and other means for diagnosing and resolving such technical problems. Applicant has discovered problems with current systems for identifying and resolving technical problems occurring with an among devices, systems, networks, and other configurations of computing devices. Through applied effort, ingenuity, and innovation, Applicant has solved many of these identified problems by developing solutions embodied in the present disclosure, which are described in detail below.

### BRIEF SUMMARY

In general, embodiments of the present disclosure provided herein provide improved operational support data object(s) corresponding to particular malfunction(s). Other implementations for providing improved operational support data object(s) corresponding to particular malfunction(s) will be, or will become, apparent to one with skill in the art upon examination of the following figures and detailed description. It is intended that all such additional implementations be included within this description, be within the scope of the disclosure, and be protected by the following claims.

In accordance with a first aspect of the disclosure, a computer-implemented method for using varied device activity data from a dynamic home communications network to select a predicted operational support data object from a device operational support management repository is provided. In some example embodiments of the computer-implemented method, the computer-implemented method is performed by specially configured computing device(s) embodied in hardware, software, firmware, and/or any combination thereof. One example embodiment computer-implemented method includes identifying, in real-time, a device identification data set associated with a networked device set communicable with the dynamic home communications network. The example computer-implemented method further includes retrieving a device activity data set associated with networked device set. The example computer-implemented method further includes applying a malfunction classification data model to the device activity data set to select the predicted operational support data object from the device operational support management repository, where the malfunction classification data model is trained based on training data from the dynamic home communications network, external aggregated device activity data from one or more external dynamic home communications networks, and malfunction device history data from the device operational support management repository. The example computer-implemented method further includes outputting the predicted operational support data object to a client device in communication with the dynamic home communications network.

Additionally or alternatively, in some embodiments of the example computer-implemented method, the predicted operational support data object includes a data link to a solution page associated with remediating malfunction classification data associated with the networked device set.

Additionally or alternatively, in some embodiments of the example computer-implemented method, the example computer-implemented method further includes determining malfunction classification data associated with the networked device set by at least: identifying first device identification data from the device identification set, the first device identification data associated with a first device of the networked device set; and determining the malfunction classification data corresponding to the first identification data and the device activity data set.

Additionally or alternatively, in some embodiments of the example computer-implemented method, the example computer-implemented method further includes determining malfunction classification data associated with the networked device set by at least: identifying a plurality of device identification data from the device identification data set, the plurality of device identification data associated with a plurality of networked devices of the networked device set; and determining the malfunction classification data corresponding to the plurality of device identification data and the device activity data set.

Additionally or alternatively, in some embodiments of the example computer-implemented method, the example computer-implemented method further includes determining malfunction classification data associated with the networked device set by at least determining the device activity data set indicates a first malfunction classification represented by the malfunction classification data.

Additionally or alternatively, in some embodiments of the example computer-implemented method, the device operational management repository includes at least the predicted operational support data object associated with a set of device types and at least one malfunction classification identifier in malfunction classification data associated with the networked device set, and where the device identification data set indicates the networked device set includes one or more networked devices of the set of device types.

Additionally or alternatively, in some embodiments of the example computer-implemented method, the example computer-implemented method further includes identifying a first malfunction classification associated with a set of device types; and storing first malfunction classification data representing the first malfunction classification associated with the set of device types; and determining malfunction classification data associated with the networked device set associated with the networked device set by at least: identifying, based at least in part on the device identification set, a device type for each of one or more networked devices of the networked device set; and determining the set of device types associated with the first malfunction classification data includes the device type for each of the one or more networked devices of the networked device set.

Additionally or alternatively, in some embodiments of the example computer-implemented method, the example computer-implemented method further includes identifying historical activity data; determining the historical activity data indicates a first malfunction; and storing a first malfunction classification identifier representing the first malfunction associated with the historical activity data.

In accordance with a second aspect of the disclosure, an apparatus for using varied device activity data from a dynamic home communications network to select a predicted operational support data object from a device operational support management repository is provided. In some example embodiments of the apparatus, the apparatus includes at least one processor and at least one non-transitory memory having computer-coded instructions stored thereon that, in execution with the at least one processor, cause the apparatus to perform any one of the example computer-implemented methods described herein. In yet some other example embodiments of the apparatus, the apparatus includes means for performing each step of any one of the example computer-implemented methods described herein.

In accordance with a third aspect of the disclosure, a computer program product for using varied device activity data from a dynamic home communications network to select a predicted operational support data object from a device operational support management repository is provided. In some example embodiments of the computer program product, the computer program product includes at least one non-transitory computer-readable storage medium having computer-coded instructions stored thereon, the computer-coded instructions in execution by at least one processor configure the computer program product for performing any one of the example computer-implemented methods described herein.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates a block diagram of a system specially configured to enable embodiments of the present disclosure;

FIG. 2 illustrates a block diagram of an example malfunction support apparatus configured in accordance with an example embodiment of the present disclosure;

FIG. 3 illustrates a schematic visualization of example device activity data associated with various networked devices on a dynamic home communications network in accordance with at least some example embodiments of the present disclosure;

FIG. 4 illustrates a schematic visualization of example device activity data associated with various networked devices embodying a dynamic home communications network in accordance with at least some example embodiments of the present disclosure;

FIG. 5 is a schematic illustration of an example malfunction support system disposed in communication with various example dynamic home communication networks in accordance with embodiments of the present disclosure;

FIG. 6 illustrates an example data representation of operational support data objects stored within a system operational support management repository in accordance with at least some embodiments of the present disclosure;

FIG. 7 illustrates an example data representation of operational support data objects associated with malfunction classification identifiers in accordance with at least some embodiments of the present disclosure;

FIG. 8 illustrates an example visualization of predicted operational resource selection utilizing a malfunction classification data model in accordance with at least some embodiments of the present disclosure;

FIG. 9 illustrates a flowchart depicting example operations of an example process for selecting and outputting a predicted operational support data object in accordance with at least some example embodiments of the present disclosure;

FIG. 10 illustrates a flowchart depicting example operations of an example process for determining malfunction classification data based at least in part on particular device identification data in accordance with at least some example embodiments of the present disclosure;

FIG. 11 illustrates a flowchart depicting example operations of an example process for determining malfunction classification data based at least in part on a plurality of device identification data in accordance with at least some example embodiments of the present disclosure;

FIG. 12 illustrates a flowchart depicting example operations of an example process for determining malfunction classification data based on a set of device types in accordance with at least some example embodiments of the present disclosure; and

FIG. 13 illustrates a flowchart depicting example operations of an example process for storing malfunction classification data associated with one or more malfunction(s) in accordance with at least some example embodiments of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### Overview

Modern households have developed into complex technological hubs that are critical to the global economy. Such technology hubs are expected to seamlessly enable rapidly changing and dynamically expanding remote work, gaming, ecommerce, media and entertainment, and Internet of Things platforms. They are generally organized into dynamic home communications networks that, given their complexities, can be difficult to maintain and support to ensure that all aspects of such networks remain functional.

Dynamic home communications networks are variable and ever-changing in that new devices are frequently connecting while previously connected networked devices are frequently disconnecting. Such connections and disconnections must be flawlessly managed, or network degrading errors can occur. Additionally, any networked device of the dynamic home communications network may experience a malfunction that impacts its connectivity to the network, its interoperability with other network devices, and/or its intended operations whether considered alone or within the broader context of the dynamic home communications network.

Identifying, isolating, and resolving device or system malfunctions can be particularly difficult given the complex and rapidly changing nature of dynamic home communications networks. Homeowners are not trained IT professionals and are thus ill-equipped to identify and root cause the source of any device or system malfunction. Additionally, devices operating on a dynamic home communication network are not typically configured to specifically operate with other devices that may be added to the network or in proximity to nearby interferers that may be present in the home environment, which can create errors or malfunctions that are difficult to identify and resolve.

Various resources may be helpful to resolve malfunction(s); however, locating helpful resources from the enormous assortment of malfunction related content often requires having a reasonable understanding of the real time status of each network device and having some idea as to the interferer landscape present in a home environment. The dynamic nature of home communication networks can also render malfunction resolution resources obsolete particularly in circumstances where such resources embody static content that is printed or downloaded and stored to some network repository. It is important that malfunction resolution content is constantly refreshed and updated as may be needed depending on the changing real-time circumstances of a particular home communication network.

Embodiments of the present disclosure provide for automatic provision of operational support data object(s). Specifically, operational support data object(s) are identified and provided for resolving particular malfunction(s) that are affecting or may affect one or more networked device(s) identified on a dynamic home communications network, such as a dynamic home communications network. In some contexts, the operational support data object(s) embody the resource(s) that are associated with a most likely malfunction, and/or that are determined as most likely to assist in resolving likely malfunction(s).

Some embodiments of the present disclosure utilize a malfunction classification data model that is specially trained and/or otherwise configured to determine predicted operational support data object(s) based at least in part on particular input data. Such input data may include device activity data, external aggregated device activity data, malfunction device history data, and/or the like. The predicted operational support data object(s) identified and/or otherwise determined by the malfunction classification data model may be outputted to one or more client device(s), networked device(s), and/or the like, for use in resolving one or more malfunction(s).

In a particular example context, embodiments of the present disclosure select and output predicted operational support data object(s) for networked device(s) on or associated with a dynamic home communications network (e.g., active networked devices currently connected to the dynamic home communications network, or inactive networked devices previously detected on the dynamic home communications network but no longer connected). Such predicted operational support data object(s) may be particular to the networked devices experiencing system malfunction(s), likely to experience malfunction(s), and/or otherwise likely to be of interest to users focused on optimizing device or network performance. Predicted operational support data object(s) may also be particular to network malfunction(s) that are caused by device interoperability issues, environmental interferers, or other system or network factors.

As the topology of the dynamic home communications network changes (e.g., by connection of new networked devices or previously inactive networked devices, and/or by disconnection of previously active networked devices), such selected and outputted predicted operational support data object(s) may similarly be updated to account for the updates in the topology. For example, if newly introduced networked device(s) are experiencing or begin experiencing one or more malfunction(s), predicted operational support data object(s) may be selected and/or outputted that are helpful to resolve such malfunction(s). Alternatively or additionally, if one or more networked device(s) contribute or may likely contribute to one or more malfunction(s) that affect the dynamic home communications network, predicted operational support data object(s) may be identified, selected, and/or outputted to resolve such malfunction(s), even in circumstances where such malfunction(s) have yet to manifest.

Some embodiments maintain and/or otherwise provide access to one or more third-party operational support data object(s). The third-party operational support data object(s) may be made accessible as corresponding to particular malfunction(s). Such third-party operational support data objects may be maintained and/or updated by systems external to the embodiments described herein. The third-party operational support data object(s) may be updated to ensure that content embodied therein remains up-to-date and does not become obsolete with respect to particular malfunction(s). As new or updated third-party operational support data object(s) are created or otherwise become available, such embodiments of the present disclosure are similarly updated to enable selection and/or output of such third-party operational support data object(s) in circumstances where particular corresponding malfunction(s) are identified and/or likely within a particular dynamic home communications network.

Embodiments of the present disclosure provide a myriad of technical improvements to various technical fields. For example, some embodiments of the present disclosure provide predicted operational support data objects that enable proactive resolution of particular malfunction(s) affecting a device, system, network, and/or interoperability therebetween. In this regard, embodiments improve the overall operational functionality of the individual networked device(s) and/or the communications network (e.g., a dynamic home communications network) itself based at least in part on providing relevant predicted operational support data objects that accurately identify and resolve malfunction(s) of interest (actual or potential) based on the configuration and/or topology of the communications network. Some embodiments realize such advantages automatically (e.g., in circumstances where operational support data objects are provided that are automatically executed, such as software applications, instructions, and/or the like). Other embodiments realize such advantages by prompting various user-initiated malfunction resolution actions.

Additionally or alternatively, embodiments of the present disclosure provide various technical advantages to the networked devices on a dynamic home communications network and/or the dynamic home communications network itself, as well as to the malfunction support system assisting in maintaining the functionality of such networked devices and/or the dynamic home communications network. For example, embodiments of the present disclosure improve individual device, system, and network uptime by assisting in prompt resolution of technical malfunctions with greater efficiency and accuracy. Additionally or alternatively, embodiments of the present disclosure reduce wasteful network load affecting a dynamic home communications network by reducing and/or minimizing error-related inefficiencies affecting the dynamic home communications network. Additionally or alternatively still, embodiments of the present disclosure reduce computing resources required to store operational support data object(s) for providing, thus reducing the storage space that would otherwise be dedicated towards locally storing complete operational support data object(s). In this regard, embodiments of the present disclosure improve both the functioning of the device(s) and/or system(s) that provide such operational support data object(s) for networked devices, while simultaneously improving both the functioning of the networked device(s) and/or system(s) embodying or connected to a dynamic home communications network itself.

Embodiments of the present disclosure provide further technical improvements to the functioning of individual networked devices themselves (e.g., by improving operational functionality thereof). Additionally or alternatively, embodiments of the present disclosure provide technical improvements to the functioning of dynamic home communications networks themselves (e.g., by improving interoperability and/or functionality thereof, and/or enabling configuration of the communications network to meet particular user-defined goals and/or preferences). Additionally or alternatively, embodiments of the present disclosure provide improved accuracy of operational support data objects (e.g., a technical improvement) provided within the technical field of preventing and/or resolving malfunctions. Additionally or alternatively still, embodiments of the present disclosure provide technical improvements within the field of resource storage and maintenance by enabling provision of third-party operational support data objects without involving active updating steps performed by the embodiments described herein.

### Definitions

The term “user” refers to an entity controlling one or more device(s). Non-limiting examples of a user include a person, an organization, or a group of people in control of a client device having access to a communications network.

The term “requesting client device” refers to a computing device embodied in hardware, software, firmware, and/or a combination thereof, that enables access to support functionality associated with one or more client device(s), system(s), and/or one or more communications network(s). A client device may execute a browser application configured to access a web-based application providing such support functionality and/or execute a native application that provides the support functionality, and/or which in turn communicates with the web-based application.

The term “user input” refers to any user interaction with a client device that initiates a process via the client device. Non-limiting examples of user input include a user gesture via a touch screen or interactive display (e.g., a tap, swipe, pinch, multi-touch, multi-tap, and custom gesture), a voice command, a peripheral input, a keyboard keystroke, a mouse click or mouse-over, a scroll input, a video-detected action, and a data input.

The term “communications network” refers to an interconnected one or more computing device(s) embodied in hardware, software, firmware, and/or a combination thereof, that enables transmission of data between such one or more computing devices. Non-limiting examples of a communications network includes a public network (e.g., the Internet), a private network (e.g., a home network, an enterprise network), a cellular network, and a hybrid network.

The term “dynamic home communications network” refers to a communications network associated with one or more user identifiers that defines network access within the home environment of the user associated with the user identifier. A dynamic home communications network embodies an internal network and/or sub-network (e.g., a sub-network of the Internet) that includes any number of networked devices of varying device types. In some embodiments, a dynamic home communications network includes, without limitation, one or more router(s), modem(s), gateway(s), signal repeater(s), smart device(s), mesh networking device(s), and/or wired or wireless access points that communicate with networked devices via any of a myriad of home networking protocols including without limitation, Internet Protocol (IP), IEEE 802.11 (Wi-Fi), Bluetooth, Zigbee, wireless universal serial bus (USB), ethernet category 5, Matter and/or other wired or wireless transmission protocols. At any given time, a dynamic home communications network includes an “active networked device set” that includes all networked devices currently connected to the dynamic home communications network for purposes of communicating, and an “inactive networked device set” that includes all networked devices that are capable of connecting to the dynamic home communications network and/or previously have connected to the dynamic home communications network but that are not currently connected to the dynamic home communications network.

The term “networked device” refers to a computing device connected to, authenticated by, or otherwise part of a communications network. Non-limiting examples of a networked device include client device(s) for one or more end user(s) of a communications network, a router, a switch, a relay, a base station, intracontinental and/or transcontinental network wiring, a communications satellite, and a cellular communications tower. The term “networked device set,” when used with respect to a particular communications network, refers to two or more networked device(s) of that communications network.

The term “malfunction” refers to a state of diminished, erroneous, or otherwise abnormal operation of a computing device, a plurality of computing devices, and/or connectivity between two or more computing devices associated with a particular communications network

The term “device identification data” refers to data and/or metadata that uniquely identifies the networked device. Device identification data for a particular networked device is generated by and retrievable from the networked device itself or is assigned to the networked device by another system external from the particular networked device and retrievable from said external system. A networked device associated with device identification data is actively connected to, or otherwise associated with, a communications network, or may be inactive on the communications network. Non-limiting examples of device identification data include device international manufacturer equipment identifier(s) (IMEI), Internet protocol address(es) (IP), media access control address(es) (MAC address), hardware identifier(s), user-input unique device name(s), and/or automatically generated device identifier(s) from a central system. In some embodiments, device identification data is retrieved and/or received by a malfunction support system monitoring a communications network via direct communication with each networked device on said communications network, and/or indirectly from one or more particular networked device(s) of said communications network that aggregate such data. Device identification data is usable by one or more computing device(s), including a malfunction support system, to identify the particular identities and/or device types of networked devices embodying and/or connected to a communications network.

The term “device activity data” refers to electronically managed data received from a networked device or generated based at least in part on monitoring one or more properties of networked device(s). Device activity data represents system-initiated and/or user-initiated action(s) alter configuration data of the networked device(s) associated with a communications network, or indicate an attempt to resolve one or more malfunction(s) (e.g., represented by one or more malfunction classification identifier(s)) associated with the networked device(s) associated with the communications network. In some embodiments, particular device activity data associated with a particular networked device is dependent on the particular device type of the networked device, such that different device types are associated with different data properties represented by device activity data. In some embodiments, device activity data is retrieved and/or received by a malfunction support system monitoring a communications network via direct communication with each networked device on said communications network, and/or indirectly from one or more particular networked device(s) of said communications network that aggregate such device activity data by communicating with the networked devices directly. Device activity data is usable by one or more computing device(s), including a malfunction support system, to determine the data values currently representing configurations of various data properties of one or more of the networked devices embodying and/or connected to a communications network, and/or process such data values to perform one or more determinations and/or apply to one or more model(s) as described herein. In some embodiments, device activity data includes a device make and/or a device model identified from data received from or otherwise associated with the networked device on a particular communications network.

The term “support activity data” refers to electronically managed data representing user-initiated action(s) associated with initiating and/or receiving technical support for a malfunction represented by a malfunction classification identifier. Support activity data is generated via one or more client device(s) interacting with a malfunction support system and is retrievable from one or both of the client device(s) and/or the malfunction support system. Non-limiting examples of support activity data includes user-inputted search query/queries for operational support data object(s) associated with a malfunction classification identifier, data representing user interaction with a support user interface, chat log data of a malfunction support session between a user utilizing a client device and a technician utilizing a technician device (e.g., describing a malfunction), and user interaction(s) with an automated system for providing technical support data and/or help. In some embodiments, support activity data includes a device make and/or a device model identified from one or more user communication(s), user input(s), and/or the like. Additionally or alternatively, in some embodiments, support activity data includes data indicating a length of time a malfunction has been impacting one or more device(s), system(s), communication network(s), and/or the like. Support activity data is usable by one or more computing device(s), including a malfunction support system, to provide context to a malfunction a networked device associated with a user is experiencing, and/or the action(s) that a user has already performed in attempts to resolve the malfunction. In some embodiments, a malfunction support system process(es) such support activity data to perform such determinations and/or apply to one or more model(s) as described herein.

The term “operational support data object” refers to electronically managed data embodying, or that is utilized to retrieve, data that improves, resolves, and/or troubleshoots a malfunction that affects one or more computing device(s) and is represented by a malfunction classification identifier. An operational support data object provides access to a data file stored locally and/or external to a malfunction support system, where the data file includes without limitation text content data, webpage data, video data, audio data, data instructions, or software application(s) for improving, solving, and/or troubleshooting one or more malfunction(s) represented by corresponding malfunction classification identifier(s) associated with one or more computing device(s). An operational support data object is generated and stored by a malfunction support system to provide access to the data file. Non-limiting examples of an operational support data object includes a text file, a web page, a PDF, and a link to a hosted web resource. “Third-party operational support data object” specifically refers to an operational support data object maintained on a data system separate from a malfunction support system and made accessible via a link or other resource identifier stored to the malfunction support system. A malfunction support system maintains access to any number of operational support data objects.

The term “predicted operational support data object” refers to a particular operational support data object identified to aid in resolving an identified malfunction corresponding to a particular malfunction classification identifier. A malfunction support system utilizes a malfunction classification data model to determine the operational support data object is associated predicted as likely to assist in resolving a particular malfunction determined affecting or likely affecting one or more networked devices. In some embodiments, a malfunction support system generates a confidence score associated with an operational support data object that indicates the likelihood that the operational support data object assists in resolving a malfunction affecting one or more networked device(s) associated with a particular user profile identifier, and determines the operational support data object is to be provided where the confidence score is above a particular minimum confidence threshold.

The term “operational support data object set” refers to one or more data object(s) embodying and/or storing any number of operational support data object(s). When used with respect to a particular malfunction classification identifier, an operational support data object set refers to any number of operational support data objects that may be utilized to improve or otherwise resolve the malfunction classification identifier.

The term “malfunction classification data model” refers to a statistical, algorithmic, and/or machine learning model specially trained to identify associations between data indicative of a possible malfunction corresponding to a malfunction classification identifier of one or more networked device on a communications network and any number of third-party operational support data object(s) that may be used to resolve or improve the possible malfunction classification identifier.

The term “malfunction classification identifier” refers to electronically managed data or unique identifier that uniquely represents a malfunction in the technical operation of a particular computing device or system comprising a plurality of computing devices, a malfunction in the technical operation of a communications network, and/or a malfunction in the interoperability between two or more computing devices. Non-limiting examples of a malfunction classification identifier include data representing a problem with connecting a computing device to a communications network, an issue in interoperability between a first computing device and a second computing device, an interoperability problem or failure in connectivity between a computing device and a peripheral, performance hardware component(s) of a computing device below a particular threshold, a drop in performance of hardware component(s) of a computing device over a particular time interval or upon occurrence of a particular event represented in device activity data, crash of a software application, unexpected shutoff of the computing device, loss of network connectivity of the computing device, and existence of malware, spyware, computer virus(es), and the like. In some embodiments, system operational support classification identifiers exist that identify multiple levels of granularity, such that a first system operational support classification identifier includes one or more subsystem operational support classification identifiers. In a non-limiting example context, a system operational support classification identifier embodying a “printer problems” class of technical problems is associated with different sub-identifiers embodying particular problem types (e.g., “printer connectivity problems,” “printer printing problems,” “printer ink problems,” and the like) and/or different sub-identifiers embodying problems for particular instances of devices and/or systems (e.g., “Printer Brand A printing problems,” and “Printer Brand B printing problems,” and/or “Printer Brand A Model 1 printing problems,” and “Printer Brand A Model 2 printing problems”). The term “malfunction classification data” refers to electronically managed data that represents one or more malfunction classification identifier(s) determined to be affecting or probable as likely to affect a computing device, a group of computing devices, and/or a communications network embodying two or more computing devices.

The term “system operational support management repository” refers to one or more electronically maintained databases embodied in hardware, software, firmware, and/or a combination thereof, that stores any number of operational support data objects and/or associations between operational support data object(s) and operational support classification identifier(s). In one non-limiting example context, a system operational support management repository includes operational support data objects, each stored together with malfunction classification identifiers that the operational support data object is determined to resolve.

The term “malfunction support session” refers to an authorized connection between a client device and a technician device that enables the provision of technical support a technician via the technician device to a user of the client device. A malfunction support session enables data transfer between the client device and the technician device, which provides text data, video data, access control to the client device, and/or configuration of one or more networked device(s) communicable via the client device.

The term “malfunction text description data” refers to text data transmitted as part of a malfunction support session by a client device and/or technician device associated with the malfunction support session. Malfunction text description data includes user-inputted text data includes freeform text data and/or text data selected from a predetermined set of available text element(s). Malfunction text description data is stored to and/or processed by the client device and/or technician device, and/or in some embodiments is processed by an intermediary device facilitating the malfunction support session, for example a malfunction support system or associated subsystem dedicated to maintaining such malfunction support session(s). In some embodiments, a malfunction support system identifies and/or receives malfunction text description data, and stores such malfunction text description data associated with a particular user profile identifier as support activity data for processing as described herein, for example as input to a malfunction classification data model.

The term “support search data” refers to electronically managed data inputted via a client device that is associated with a user search for technical support associated with one or more malfunction classification identifier(s). In some embodiments, the support search data includes user-inputted text data that represents a user’s description of the malfunction represented by the malfunction classification identifier. Support search data is stored to and/or processed by the client device, and/or in some embodiments an intermediary device facilitating searching for operational support data object(s) and/or data associated with particular malfunction(s), for example a malfunction support system and/or associated subsystem dedicated to facilitating such searching. In some embodiments, a malfunction support system identifies and/or receives support search data, and stores such support search data associated with a particular user profile identifier as support activity data for processing as described herein, for example as input to a malfunction classification data model.

The term “support user interface” refers to a user interface that includes one or more interface elements associated with providing access to a malfunction support session. In some embodiments, a support user interface includes a plurality of sub-interfaces that each provide access to different data and/or functionality associated with providing technical support functionality.

The term “main support transmission process” refers to computer-driven process for initiating, maintaining, and engaging with a malfunction support session. A main support process is performed separate from one or more secondary support process(es) that operate in parallel with the main support process. A main support transmission process is maintained in parallel with any number of side process(es), for example where one or more side process(es) facilitate identification of predicted operational support data object(s) to provide and/or display of such predicted operational support data object(s). Non-limiting examples of a secondary support process includes a process that provides operational support data object(s) associated with one or more identified malfunction classification identifier(s) dynamically as a user engages with a main support transmission process.

The terms “training data” and “set of training data” refer to electronically managed data used to train a particular malfunction classification data model to identify malfunction classification identifier(s) corresponding to malfunction(s) likely affecting a particular communications network (e.g., a dynamic home communications network), and/or to identify predicted operational support data objects determines as likely to assist in resolving the malfunction(s). Training data represents all or at least a portion of available historical data associated with particular operations, configurations, and/or interactions associated with a dynamic home communications network and/or one or more other dynamic home communications network(s), and/or user profile identifier(s) associated with a dynamic home communications network and/or plurality of dynamic home communications networks. In some embodiments, training data is processed during training such that trends, patterns, data-driven indicators, and/or other predictive determinations are learned from such data by the malfunction classification data model. In some embodiments, training data includes various data received, retrieved, normalized, and/or aggregated from a particular dynamic home communications network and/or one or more dynamic home communications networks external from the particular dynamic home communications network. Non-limiting examples of data of training data include historical device activity data associated with the particular dynamic home communications network, historical device activity data associated with one or more external dynamic home communications networks, historical support activity data associated with the particular dynamic home communications network, historical support activity data associated with one or more external dynamic home communications networks, malfunction device history data representing historical malfunctions affecting networked devices having particular other data associated therewith (e.g., device activity data, support activity data, particular network topology data for a dynamic home communications network, and/or the like) stored by a malfunction support system via a device operational support management repository, external data indicating device malfunction trend(s) and/or occurrences (e.g., web article(s) and/or web-scraped data indicating an increase in users reporting a particular malfunction for a particular device type), and/or other available data from which malfunction(s) associated with a dynamic home communications network may be identified and/or from which it is determinable whether a particular operational support data object is likely to assist in resolving one or more malfunction(s) affecting a dynamic home communications network.

A set of training data includes any desired portion of available data associated with one or more dynamic home communications networks and from which such trends, patterns, data-driven indicators, and/or other predictive determinations are to be learned. In some embodiments, a training data set utilized to train a particular model includes a select subset of desired portions of historical device activity data, support activity data, other data indicative of previous operational support data object(s) served associated with networked device(s) of the dynamic home communications network, interaction(s) with such operational support data object(s), external system data (e.g., blog data, article data, and/or other web data from one or more predefined or determined external sources). For example, in one embodiment, the set of training data may include one or more of data representing a make and/or a model of the devices(s), data representing a description of the issue, any search words to resolve the perceived problem, data representing the duration of ongoing problem, and/or historical data related to the matter/problem (e.g., a malfunction). In some contexts, training data includes a subset of data associated with one or more dynamic home communications networks with which the trained model is to be utilized. In some contexts, training data includes data associated with all available dynamic home communications networks. During training, the training set of data is processed by the malfunction classification data model to enable the malfunction classification data model to identify data trends, patterns, and/or other linkages in the training set of device activity data.

### Example Systems and Apparatuses of the Disclosure

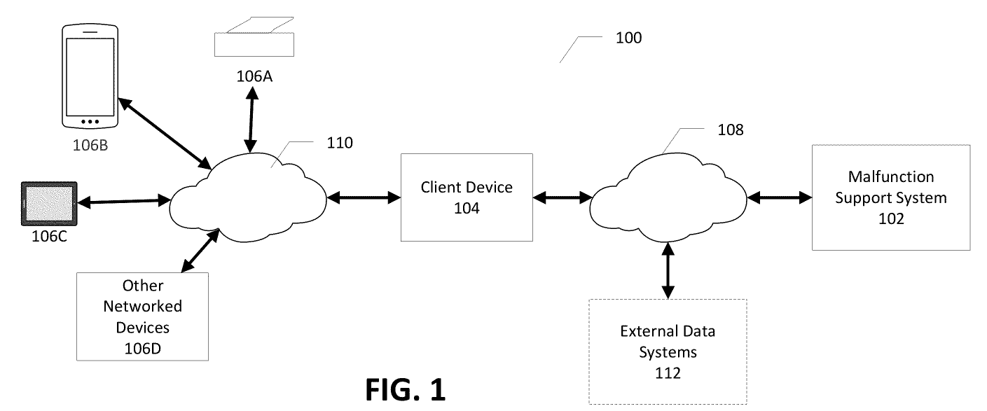

FIG. 1 illustrates a block diagram of a system specially configured to enable embodiments of the present disclosure. Specifically, FIG. 1 depicts an example system 100 configured to enable selection and provision of predicted operational support data object(s). The system 100 includes a malfunction support system 102, external data system(s) 112, a client device 104, any number of networked devices, including a printer represented by networked device 106A, a smartphone represented by networked device 106B, a tablet represented by networked device 106C, and one or more other networked device(s) 106D (the networked devices 106A-106D collectively “networked devices 106”). The networked devices 106 are communicable with one another and/or one or more other device(s), such as the client device 104, over a first, dynamic home communications network 110. The malfunction support system 102 is communicable with one or more other device(s), such as the external data system(s) 112 and/or the client device 104, over a second communications network 108.

The malfunction support system 102 includes one or more computing device(s) embodied in hardware, software, firmware, and/or a combination thereof, that provides predicted operational support data object selection and provision functionality. For example, in some embodiments the malfunction support system 102 embodies or otherwise be included in a system that provides a user automatic and/or technician-based support associated with one or more networked device(s) and/or a dynamic home communications network associated therewith. The malfunction support system 102 trains and/or otherwise maintains a malfunction classification data model, utilizes the malfunction classification data model to select one or more predicted operational support data object(s), and/or output predicted operational support data object(s). in some embodiments, the malfunction support system 102 provides such functionality via a client device, such as the client device 104, associated with any number of computing device(s), such as one or more of the networked device(s) 106. In some embodiments, the malfunction support system 102 maintains one or more repositories that store operational support data object(s), data links for accessing operational support data object(s) (including third-party operational support data object(s)), and/or associations between operational support data object(s) and malfunction classification identifier(s).

The external data systems 112 includes any number of data systems external to the malfunction support system 102. Each external data system of the external data systems 112 includes one or more computing device(s) embodied in hardware, software, firmware, and/or a combination thereof, that hosts, stores, and/or otherwise provides access to one or more operational support resource(s). For example, in some embodiments, the external data systems 112 includes one or more third-party web server(s) that hosts content associated with particular malfunction(s). Such content may include web page(s), video(s), image(s), article(s), manual(s), and/or other text content, application(s) that diagnose and/or attempt to resolve certain malfunction(s), and/or the like. It should be appreciated that in some embodiments each external data system is controlled by a different entity, and/or that each external data system maintains operational support data object(s) associated with particular malfunction(s). For example, in some embodiments, each external data system controlled by a particular entity embodying a device manufacturer maintains operational support data object(s) associated with the device(s) and/or system(s) made available by the device manufacturer. Alternatively or additionally, for example, an external data system embodying a technical support forum platform may include operational support data object(s) associated with various malfunction(s) that may affect various types, makes, models, and other variations of device(s) or combination of device(s).

The client device 104 includes any number of computing device(s) embodied in hardware, software, firmware, and/or a combination thereof that provides a user access to functionality of the malfunction support system 102, and/or one or more of the networked devices 106. In some embodiments, the client device 104 is embodied by a user device owned, operated, and/or otherwise controlled by a particular user. Non-limiting examples of a client device 104 include a specially configured smartphone, personal computer, tablet, laptop, smart watch, smart television, wearable, virtual reality device, virtual assistant device, and/or the like. The client device 104 may be specially configured to provide access to such functionality via one or more software application(s) (e.g., “apps”) installed to and/or otherwise executable via the client device 104. In some embodiments, the client device 104 includes or is communicable with one or more connected devices that provides processing, communication, networking, display, and/or other functionality. For example, in some embodiments the client device 104 includes a smart watch paired with a smartphone, where the smart watch displays information processed and/or retrieved via the smartphone and transmitted from the smartphone to the smart watch over a short-range communications network (e.g., a Bluetooth connection). In some embodiments, the client device 104 accesses one or more third-party application(s) (e.g., third-party messaging, email, and/or other communications application) that provides data outputted from the malfunction support system 102.

The communications network 108 includes any number of computing device(s) embodied in hardware, software, firmware, and/or a combination thereof, that enables transmission of data to and/or from one or more other device(s) connected thereto. For example, in some embodiments and as depicted, the communications network 108 enables transmission of data between the malfunction support system 102 and/or the external data systems 112. Additionally or alternatively, in some embodiments the communications network 108 enables transmission of data between the client device 104 and the malfunction support system 102. Additionally or alternatively still, in some embodiments, the communications network 108 enables transmission of data between the client device 104 and some or all of the external data system 112.

The communications network 108 may embody any of a myriad of network configurations. In some embodiments, the communications network 108 embodies a public network (e.g., the Internet). In some embodiments, the communications network 108 embodies a private network (e.g., an internal network between particular devices). In some other embodiments, the communications network 108 embodies a hybrid network (e.g., a network enabling internal communications between particular connected devices and external communications with other devices). The communications network 108 may include one or more base station(s), relay(s), router(s), switch(es), cell tower(s), communications cable(s) and/or associated routing station(s), and/or the like. In some embodiments, the communications network 108 includes one or more user controlled computing device(s) (e.g., a user owner router and/or modem) and/or one or more external utility devices (e.g., Internet service provider communication tower(s) and/or other device(s)).

In some embodiments, the first, dynamic home communications network 110 embodies a private network enabling communication between the various networked devices 106 and the client device 104. In some embodiments, for example, the dynamic home communications network 110 embodies a home network that enables communication between various devices on the home network, such as a network connected printer (networked device 106A), a user’s smartphone (networked device 106B), a user’s tablet (networked device 106C), other networked devices 106D such as other user’s smartphones, personal computers, laptops, smart televisions and/or other Internet-of-things enabled devices, virtual assistant devices, home security systems, and/or the like. The user may utilize one or more such device(s) independently, and/or access such device(s) or configuration(s) thereof through another device connected to the dynamic home communications network 110, for example through interaction with the client device 104.

In some embodiments, device activity data is detected and/or otherwise received by the malfunction support system 102 associated with the dynamic home communications network 110, client device 104, and/or any one or more of the networked devices 106. For example, in some embodiments, the device activity data associated with each networked device connected to the dynamic home communications network 110, and/or associated with component networked devices embodying the dynamic home communications network 110 itself, is detected, requested, and/or otherwise received by the client device 104 for transmitting to the malfunction support system 102. Alternatively or additionally, in some embodiments, the malfunction support system 102 monitors the dynamic home communications network 110 directly to identify the device activity data associated with the dynamic home communications network 110 and/or networked devices 106 communicable therewith. In one example context, the he user utilizes the client device 104 to update configurations and/or otherwise affect operation of one or more of the networked devices 106, and device activity data indicating such configuration updates (e.g., configuration logs) are included in the device activity data processed via the system 100.

In some embodiments, the device activity data includes or is associated with device identification data that uniquely identifies one or more networked device(s). For example, in some embodiments, device identification data is detected and/or otherwise identified for each networked device embodying the dynamic home communications network 110 and/or that is actively connected to the dynamic home communications network 110. Alternatively or additionally, in some embodiments, device identification data is detected, received, and/or determined associated with inactive networked devices previously connected to the dynamic home communications network 110. In this regard, any number of device(s) that are experiencing malfunction(s) and/or contributing to malfunction(s) (e.g., malfunctions regarding operations of the dynamic home communications network 110 as a whole) may be identified and processed.

In some embodiments, the device activity data additionally or alternatively includes configuration data and/or logs associated with a networked device or combination of networked device(s). For example, in some embodiments, device activity data is detected, received, and/or otherwise identified that includes current configuration data (e.g., configuration properties and corresponding values) for any number of networked device(s). It should be appreciated that the particular configurations identified for each networked device may differ, for example based at least in part on the device type for each particular networked device. Additionally or alternatively, in some embodiments, device activity data is detected, received, and/or otherwise identified that includes a configuration log of historical configuration data for any number of networked device(s) and/or changes in configurations of the networked device(s).

Additionally or alternatively, in some embodiments, support activity data is generated based on one or more initiated actions associated with diagnosing and/or resolving one or more malfunction(s). In some embodiments, for example, support activity data is generated and/or received by the malfunction support system 102 from the client device 104 that represents initiated search queries (e.g., performed via a search engine) for support regarding a malfunction, interactions with one or more support process(es) of the malfunction support system 102 and/or an associated system, and/or the like. The support activity data and/or device activity data may be generated by any of the devices as depicted and described herein, and received and/or otherwise stored by the malfunction support system 102 for processing to select one or more predicted operational support data object(s) as described herein.

At any given time, one or more of the networked devices 106 may experience a malfunction, and/or the dynamic home communications network 110 itself may experience a malfunction due to networked device(s) embodying the dynamic home communications network 110 and/or contributed to by the networked devices 106 connected thereto. For example, in one example context one or more of the networked devices 106 operate at a diminished capacity due to any of a myriad of physical and/or virtual factors, such as (1) incompatibility of hardware, software, firmware, and/or the like, (2) diminished hardware components, and (3) operation of malicious software such as spyware, malware, viruses, and/or the like. Alternatively or additionally, in another context one or more of the networked devices 106 experience an error in network connectivity. For example, the networked device 106A may lose connection with the dynamic home communications network 110 due to any of a myriad of malfunction(s), such as loss of signal by the networked device 106A, a faulty hardware component for connecting the networked device 106A to the dynamic home communications network 110, a change in configuration that prevents the networked device 106A from reconnecting to the dynamic home communications network 110, and/or the like. Additionally or alternatively, in some embodiments the dynamic home communications network 110 itself experiences one or more malfunctions, for example loss of power by one or more devices embodying the dynamic home communications network 110, loss in connection to an outside network by the dynamic home communications network (e.g., an Internet outage), reconfiguration of one or more devices of the dynamic home communications network 110 that prevents communication of traffic to and/or from one or more of the networked devices 106A, and/or the like.

Additionally or alternatively, each of the networked devices 106 may experience different types of malfunction. For example, a smart printer (e.g., embodied by networked device 106A) may experience particular operational problems that are different from those experienced by a smartphone (e.g., embodied by networked device 106B). In this regard, as the number of different types of networked devices on a particular dynamic home communications network grows, the complexity of possible malfunctions that may arise and/or need to be resolved increases.

Accordingly, it should be appreciated that as the complexity of networked devices increases (e.g., the number increases and/or the variability of devices having different characteristics increases). Such technical complexities are especially prevalent in the context of home networks. For example, in one example context of a home network embodied by dynamic home communications network 110, the networked devices 106 includes any number of networked devices, each of varying device types, makes, models, operations, and/or the like. Additionally or alternatively, one or more of such devices may be actively in communication via the network, and other networked devices may be inactive and/or otherwise not in communication via the network. The client device 104 enables interaction, as described herein, with the malfunction support system to utilize system operational support data model(s) to accurately identify and/or output predicted operational support data object(s) for assisting in resolving any one or more of various malfunction(s).

Additionally or alternatively, in some embodiments the dynamic home communications network 110 is associated with a regularly changing list of actively connected networked devices (“active networked devices”) and inactive networked devices not connected to the dynamic home communications network 110. For example in some contexts, a user handheld device regularly disconnects from the dynamic home communications network 110 as the user handheld device is relocated (e.g., for reaching out of range of the dynamic home communications network 110) and/or may dynamically reconnect (e.g., upon reentering a range of the dynamic home communications network 110). In this regard, device activity data may be identified, retrieved, and/or otherwise received that indicates the active networked devices at a particular point in time, and/or the inactive networked devices at any particular point in time. In some embodiments, such data is processable to identify particular networked devices of the dynamic home communications network 110. For example, data indicating the inactive networked devices and active networked devices is comparable over one or more time intervals to determine fixed components of the dynamic home communications network 110, such as a router, modem, and/or the like, which is/are configurable to address malfunctions associated with network connectivity of one or more networked devices and/or the dynamic home communications network 110 itself.

In some embodiments, the malfunction support system 102 outputs operational support data object(s) at particular defined times and/or upon detecting occurrence of particular event(s). For example, in some embodiments, the malfunction support system 102 continuously monitors connections, changes in configuration, and/or communications associated with the networked devices on or embodying the dynamic home communications network 110. The malfunction support system 102 in some embodiments monitors the dynamic home communications network 110 directly (e.g., in circumstances where the malfunction support system 102 is connected to the dynamic home communications network 110), or indirectly through communication with the client device 104, for example. In this regard, the malfunction support system 102 of such embodiments detects particular occurrences, triggers, satisfaction of predetermined criteria, and/or other events that trigger selection and/or outputting of predicted operational support data object(s). For example, in some embodiments the malfunction support system 102 monitors such data and determines whether one or more networked device(s) on or embodying the dynamic home communications network 110 are experiencing a malfunction or are likely to experience a malfunction, and subsequently select and/or output predicted operational support data object(s) associated with such malfunction(s). Alternatively or additionally, in some embodiments, the malfunction support system 102 initiates selection and/or outputting of predicted operational support data object(s) in response to receiving data indicative of user initiation of a particular application and/or request for particular functionality.

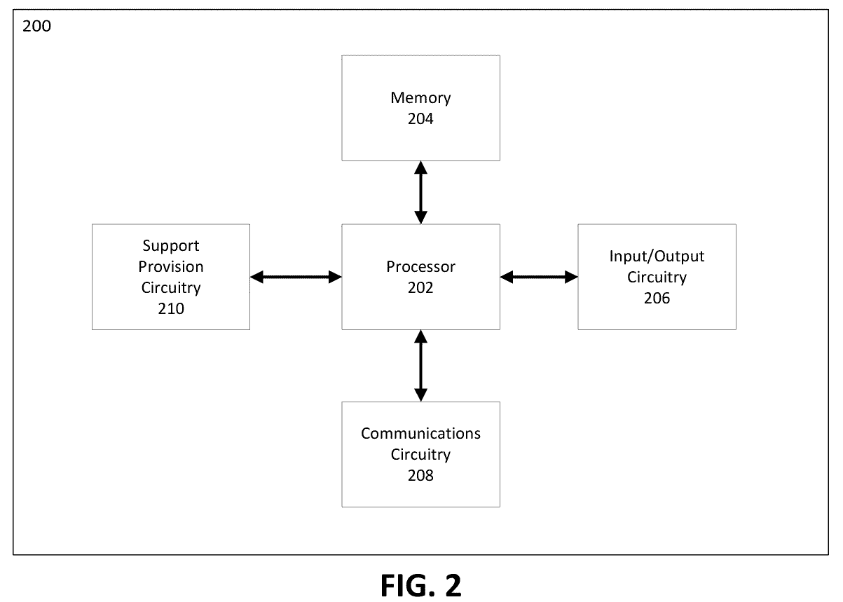

FIG. 2 illustrates a block diagram of an example malfunction support apparatus specially configured in accordance with an example embodiment of the present disclosure. In some embodiments, the malfunction support system 102 is embodied by one or more computing systems, such as the malfunction support apparatus 200 as depicted and described in FIG. 2. The malfunction support apparatus 200 includes processor 202, memory 204, input/output circuitry 206, communications circuitry 208, and support provision circuitry 210. In some embodiments, the malfunction support apparatus 200 is configured, using one or more of the sets of circuitry 202, 204, 206, 208, and/or 210, to execute the operations described herein.

Although components are described with respect to functional limitations, it should be understood that the particular implementations necessarily include the user of particular computing hardware. It should also be understood that in some embodiments certain of the components described herein include similar or common hardware. For example, two sets of circuitry may both leverage use of the same processor(s), network interface(s), storage medium(s), and/or the like, to perform their associated functions, such that duplicate hardware is not required for each set of circuitry. The user of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the malfunction support apparatus 200 provide or supplement the functionality of other particular sets of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the malfunction support apparatus 200. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 304 is configured to store information, data, content, applications, instructions, or the like, for enabling the malfunction support apparatus 200 to carry out various functions in accordance with example embodiments of the present disclosure.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the malfunction support apparatus 200, and/or one or more remote or “cloud” processor(s) external to the malfunction support apparatus 200.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed.

As one particular example embodiment, the processor 202 is configured to perform various operations associated with improved predicted operational support data object selection and provision, for example as described with respect to operation of the malfunction support system 102 and/or as described further herein. In some embodiments, the processor 202 includes hardware, software, firmware, and/or a combination thereof, that receives and/or retrieves device activity data associated with a particular client device, user profile, and/or the like. Additionally or alternatively, in some embodiments, the processor 202 includes hardware, software, firmware, and/or a combination thereof, that determines particular data satisfies triggering criteria to initiate selection and/or provision of predicted operational support data object(s). Additionally or alternatively, in some embodiments, the processor 202 includes hardware, software, firmware, and/or a combination thereof, that maintains one or more data repositories of operational support data object(s) and/or associations therewith, for example with corresponding malfunction classification identifier(s). Additionally or alternatively, in some embodiments, the processor 202 includes hardware, software, firmware, and/or a combination thereof, that maintains a malfunction classification data model. Additionally or alternatively, in some embodiments, the processor 202 includes hardware, software, firmware, and/or a combination thereof, that retrieves and/or applies input data to the malfunction classification data model. Additionally or alternatively, in some embodiments, the processor 202 includes hardware, software, firmware, and/or a combination thereof, that outputs, in real-time, a predicted operational support data object selected by a malfunction classification data model.

In some embodiments, the malfunction support apparatus 200 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user.

The communications circuitry 208 includes any means such as a device or circuitry embodied in either hardware or a combination of hardware and software that is configured to receive and/or transmit data from/to a network and/or any other device, circuitry, or module in communication with the malfunction support apparatus 200. In this regard, the communications circuitry 308 includes, for example in some embodiments, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from a client device in communication with the malfunction support apparatus 200.

The support provision circuitry 210 includes hardware, software, firmware, and/or a combination thereof, that supports various functionality associated with improved selection and/or provision of predicted operational support data object(s) associated with networked devices associated with or embodying a communications network. For example, in some embodiments, the support provision circuitry 210 includes hardware, software, firmware, and/or a combination thereof, for receiving one or more input data sets for processing via a malfunction classification data model, such as training data (e.g., historically retrieved device identifiers, other device activity, and/or the like), external aggregated device activity data, malfunction device history data, and/or the like. Additionally or alternatively, in some embodiments, the support provision circuitry 210 includes hardware, software, firmware, and/or a combination thereof, for identifying, in real-time, a device identification data set associated with a networked device set communicable with a dynamic home communications network. Additionally or alternatively, in some embodiments, the support provision circuitry 210 includes hardware, software, firmware, and/or a combination thereof, for retrieving a device activity data set associated with the networked device set. Additionally or alternatively, in some embodiments, the support provision circuitry 210 includes hardware, software, firmware, and/or a combination thereof, for applying a malfunction classification data model to the device activity data set to select a predicted operational support data object from a device operational support management repository. Additionally or alternatively, in some embodiments, the support provision circuitry 210 includes hardware, software, firmware, and/or a combination thereof, for outputting, in real-time, the predicted operational support data object to a requesting client device.

In some embodiments, the support provision circuitry 210 includes hardware, software, firmware, and/or a combination thereof, for performing additional and/or detailed subprocesses embodying such steps. For example, in some embodiments, the support provision circuitry 210 includes hardware, software, firmware, and/or a combination thereof, for determining malfunction classification data embodying one or more malfunction classification identifier(s) corresponding to particular device identification data and/or a plurality of device identification data. Additionally or alternatively, in some embodiments, the support provision circuitry 210 includes hardware, software, firmware, and/or a combination thereof, for identifying malfunction classification identifier(s) based at least in part on device type(s) for networked devices associated with a particular communications network. Additionally or alternatively, in some embodiments, the support provision circuitry 210 includes hardware, software, firmware, and/or a combination thereof, for associating malfunction classification identifier(s) with corresponding historical activity data. Additionally or alternatively, in some embodiments, the support provision circuitry 210 includes hardware, software, firmware, and/or a combination thereof, for training a malfunction classification data model based on one or more portion(s) of training data, for example training data, external aggregated device activity data, and malfunction device history data.

It should be appreciated that, in some embodiments, support provision circuitry 210 may include a separate processor, specially configured field programmable gate array (FPGA), or a specially programmed application specific integrated circuit (ASIC). Additionally or alternatively, in some embodiments, one or more of the sets of circuitries 202-210 are combinable. Alternatively or additionally, in some embodiments, one or more of the sets of circuitry perform some or all of the functionality described associated with another component. For example, in some embodiments, one or more of the sets of circuitry 202-210 are combined into a single module embodied in hardware, software, firmware, and/or a combination thereof. Similarly, in some embodiments, one or more of the sets of circuitry, for example, support provision circuitry 210 is combined such that the processor 202 performs one or more of the operations described above with respect to each of these modules.

### Example Computing Environments of the Disclosure

Having described example systems and apparatuses in accordance with the present disclosure, example computing environments and data representations in accordance with the present disclosure will now be discussed. Each of the example computing environments may be represented by visualizations of the data depicted therein. It should be appreciated that the particular data representations and data types are exemplary, and in other embodiments such data is structured and/or otherwise represented in another manner and/or other data is processed. In some embodiments, the particular data is received and/or maintained by the malfunction support apparatus 200 for processing as described herein.

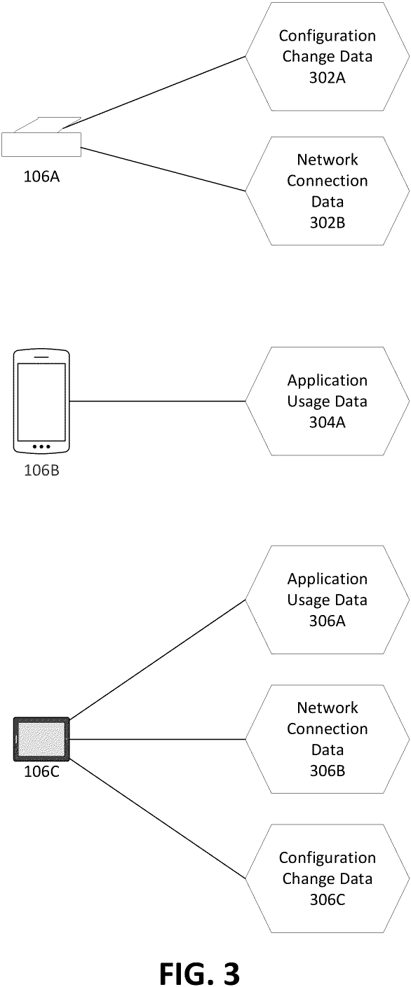

FIG. 3 illustrates a schematic visualization of example device activity data associated with various networked devices operating on a communications network in accordance with at least some example embodiments of the present disclosure. Specifically, FIG. 3 illustrates a visualization of device activity data for a plurality of networked devices that are associated with a dynamic home communications network, for example as active and/or inactive networked devices. The various portions of device activity data depicted and described are receivable, retrievable, or otherwise may be obtained from the associated networked device, determined from network traffic communicated across the communications network, and/or the like. In this regard, it will be appreciated that the device activity data may be received, retrieved, and/or maintained by the malfunction support apparatus 200.

As illustrated, the networked device 106A is associated with device activity data comprising configuration change data 302A and network connection data 302B. In some such embodiments, the networked device 106A embodies a network connected printer that is actively connected to a dynamic home communications network. The configuration change data 302A in some embodiments embodies a change log of one or more configuration properties of the networked device 106A. For example in some contexts, the configuration change data 302A includes indications of the current value of each configuration property, values for such configuration properties at previous time intervals and/or point in time, and/or other aspects regarding the operational functionality of the network connected printer. Such configuration change data 302A may be maintained by the networked device 106A, for example in a configuration log stored by the networked device 106A as the values of the configuration properties are set and/or updated. In one example context, a user interacts directly with the networked device 106A or indirectly via a client device accessing the same communications network, for example, to update the value corresponding to one or more configuration properties to a desired value. It should be appreciated that, in some embodiments, the configuration change data 302A includes detected and/or determined default values identified for one or more configuration properties that are set by default upon initiation or initial configuration of the networked device 106A.

The network connection data 302B in some embodiments embodies network authentication credentials and/or a connection history log associated with connecting to a particular communications network. For example, in some such embodiments the network connection data 302B indicates whether the networked device 106A is configured for connection to a particular communications network, the SSID, hostname, or other network identifier that the networked device 106A is configured to attempt to access, network security data such as a password the networked device 106A is configured to attempt to utilize to access a communications network, and/or the like. Additionally or alternatively, in some embodiments, the network connection data 302B includes a connection log that indicates periods of network connectivity and/or lack thereof by the networked device 106A. Alternatively or additionally still, in some embodiments, the network connection data 302B include indications of error(s) received associated with attempted network transmission(s).

In some embodiments, the configuration change data 302A and/or network connection data 302B are embodied as a time series or otherwise including timestamp(s) indicating when values for such data changed. In this regard, error(s) may be correlated to particular changes represented in one or more portion(s) of the device activity data. Additionally or alternatively, in some embodiments, one or more portion(s) of device activity data is actively monitored (e.g., during periods of active connection with the communications network) by an external device or system, for example the malfunction support apparatus 200.

As further illustrated, networked device 106B is associated with device activity data comprising application usage data 304A. In some embodiments, the application usage data 304A includes data identifiers indicating software application(s), package(s), and/or other executable(s) installed to or otherwise accessible via the networked device 106B. Additionally or alternatively, in some embodiments, the application usage data 304A includes data indicating actions performed via one or more particular software application(s), and/or operational data associated with performance of the one or more particular software application(s) (e.g., processor use, memory use, battery drain, network activity, and/or the like). Additionally or alternatively still, in some embodiments, the application usage data 304A includes crash log(s), action(s) attempted and/or performed via one or more particular software application(s), and/or other tracked interactions with one or more particular software application(s).

As further illustrated, networked device 106C is associated with device activity data comprising application usage data 306A, network connection data 306B, and configuration change data 306C. Such data portions in some embodiments include data specific to the networked device 106C and similar to that of the similarly named configuration change data 302A, network connection data 302B, and application usage data 304A, respectively. In this regard, it should be appreciated that the data properties and/or values of device activity data associated with each networked device may differ based on the individual configurations and use of each networked device. Additionally or alternatively, the device activity data associated with each particular networked device in some contexts is determined based at least in part on a device type, device property, or other characteristic of the particular networked device. Each of the portions of device activity data may be stored and/or processed individually, or may be stored and/or processed in conjunction with device activity data for one or more other networked device(s) for use in identifying particular malfunction(s) affecting the individual devices, a plurality of devices, and/or the communications network with which the networked device(s) are communicable.

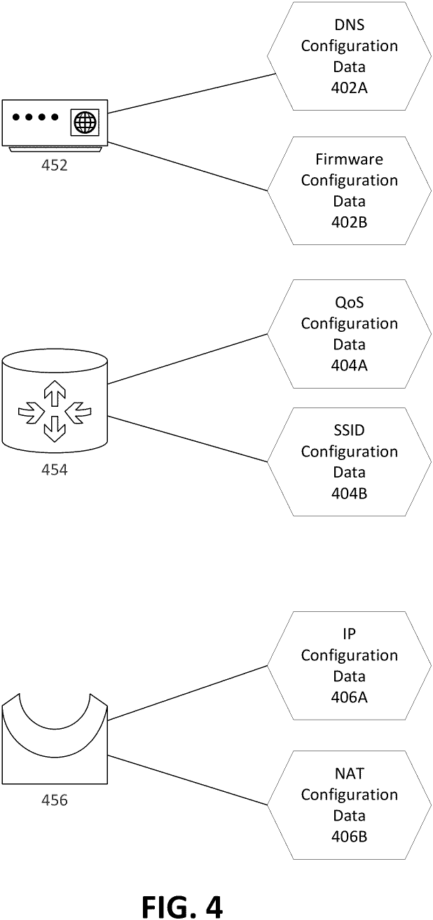

FIG. 4 illustrates a schematic visualization of example device activity data associated with various networked devices embodying a communications network in accordance with at least some example embodiments of the present disclosure. Specifically, FIG. 4 illustrates a visualization of device activity data for a plurality of networked devices that embody a dynamic home communications network. As illustrated, the communications network includes a modem 452, a router 454, and a network bridge 456. The various portions of device activity data depicted and described may be received from the associated networked device, determined from monitoring network traffic communicated via the communications network, and/or the like. In some embodiments, portion(s) of the device activity data is/are received, retrieved, and/or otherwise maintained by an external device or system, for example the malfunction support apparatus 200.

As illustrated, the modem 452 embodying a first networked device of the dynamic home communications network is associated with device activity data comprising DNS configuration data 402A and the firmware configuration data 402B. In some such embodiments, the modem 452 embodies a user-controlled device within a particular environment (e.g., the user’s home environment) that facilitates a connection to an external communications network, for example the Internet. The DNS configuration data 402A embodies configurations of a domain name system and/or for accessing one or more domain name system. Such DNS configuration data 402A may include DNS host mapping configuration data, IP addresses for such domain name systems, querying forwarding configuration data, and/or the like.

In some embodiments, the firmware configuration data 402B embodies firmware that enables interaction between the hardware and/or software configuring the modem 452. For example in some embodiments, the firmware configuration data 402B includes value(s) for one or more data properties that enable connectivity between the modem, other networked device(s), and/or an external communications network (e.g., the Internet). Firmware configuration data 402B may be updated, replaced, and/or otherwise changed in circumstances where the firmware of the modem 452 is updated to a new version and/or to be updated. In some embodiments, the firmware configuration data 402B includes a firmware update log that indicates the changes in data properties between firmware versions.

As illustrated, the router 454 embodies a second networked device of the dynamic home communications network. In one example context, the router 454 is connected to the modem 452 to enable traffic routing, wireless transmission functionality (e.g., Wi-Fi), and/or the like. The depicted router 454 is associated with QoS configuration data 404A and SSID configuration data 404B. The QoS configuration data 404A may embody quality of service (QoS) related data properties, values, and the like. in some embodiments, the QoS configuration data 404A embodies values for data properties that indicate prioritized network traffic and/or bandwidth allocation(s) for one or more device(s), application(s), and/or the like. In some embodiments, the QoS configuration data 404AA includes identifiers for one or more particular networked device(s), and bandwidth or other priority allocations for each identified networked device. Alternatively or additionally, in some embodiments, the QoS configuration data 404A includes a data log of changes to QoS related properties over time.

In some embodiments, the SSID configuration data 404B embodies data associated with configuration of a service set identifier (SSID) for the router 454 and/or related networked devices embodying the communications network. In some embodiments, the SSID configuration data 404B includes a data label that identifies the dynamic home communications network (e.g., a “network name” that may be viewed and/or utilized by a user to identify the dynamic home communications network). In some embodiments, the SSID configuration data 404B includes one or more data flags indicating whether the router is to broadcast the SSID for access by other networked devices. Alternatively or additionally, in some embodiments, the SSID configuration data 404B includes a historical configuration data log that includes previously configured SSIDs, and/or a previous data values for properties associated with configuration of the SSID. In some such embodiments, the historical configuration data log includes timestamps and/or time intervals during which changes to the configuration properties of the router 454 were applied.

As illustrated, the network bridge 456 embodies a third networked device of the dynamic home communications network. In one example context, the network bridge 456 is a specially configured networked device that bridges two independent networks and/or subnetworks into the single dynamic home communications network. In some embodiments, the network bridge 456 manages a second subset of networked devices and communicates with the router 454 that manages a first subset of networked devices to create a single, combined dynamic home communications network including both the first and second subsets of networked devices. Alternatively or additionally, in some embodiments, the network bridge 456 embodies a computing device specially configured to provide multiple types of network connection services, including bridging, internet connection sharing, network address translation (NAT), and the like. In this regard, the network bridge 456 may be set to one of any number of modes that enable each of these independent types of network connection services.

The depicted network bridge 456 is associated with IP configuration data 406A and NAT configuration data 406B. In some embodiments, the IP configuration data 406A embodies configurations of Internet protocol (IP) addresses utilized to integrate the independent communications network(s). In some embodiments, the IP configuration data 406A includes a currently assigned IP address for bridging the network bridge with another networked device (e.g., the router 454). Additionally or alternatively, in some embodiments, the IP configuration data 406A includes historical configuration data representing previously assigned IP addresses, and/or timestamps indicating when the data values for such properties were updated.

In some embodiments, the NAT configuration data 406B embodies configurations of network address translation (NAT) services performed by the network bridge 456. In some embodiments, NAT configuration data 406B indicates whether NAT services are to be utilized as an alternative to bridging the network connections of two independent communications networks (or subnetworks). Additionally or alternatively, in some embodiments, the NAT configuration data 406B includes configurations of an address pool of real host IPs utilized by a primary or host communications network. Additionally or alternatively still, in some embodiments, the NAT configuration data 406B includes configurations of virtual addresses utilized for external communications from the communications network. Additionally or alternatively still, in some embodiments, the NAT configuration data 406B includes historical configuration data for either or both of such properties, and/or the like, and in some embodiments include timestamps and/or time intervals at which the values for such configuration properties were updated. In this regard, the NAT configuration data 406B may include a historical log of such data updates.

The various configuration properties of each networked device and data values associated therewith are processable to learn circumstances in which the data values indicate a possible, likely, or existing malfunction. Additionally or alternatively, combinations of data values are processable to learn circumstances in which the combination indicates a possibility, likely, or existing malfunction. It should be appreciated that in some embodiments a rule set is generated that represents manually determined or automatically learned malfunction(s) indicated from particular data values for configuration properties or combinations thereof. Alternatively or additionally, in some embodiments an algorithmic, statistical, and/or machine learning model is configured that learns the malfunction(s) indicated by the individual data value(s) or combination thereof for one or more configuration properties.

It should be appreciated that a communications network may be embodied via and/or including any number of networked devices. In this regard, one or more additional and/or alternative networked devices may be included in a particular communications network, such as a dynamic home communications network. Each of such networked devices may store and/or be associated with its own independent configuration properties and/or data values that are relevant for purposes of providing the functionality described herein. Thus, the particular networked devices and configuration data properties depicted and described herein should not limit the scope and spirit of this disclosure.

### Example Training Data Environment of the Disclosure

Having described example systems, apparatuses, and data representations and visualizations of the disclosure, example training environments including visualizations of interacting data systems will now be described. It will be appreciated that the particular visualizations, data systems, and interactions between such data systems are exemplary, and that in some embodiments the data systems and interactions between them may actually be embodied utilizing any of a myriad of devices, systems, processes, and the like. In this regard, the particular visualizations are provided for non-limiting purposes of understanding and are not to limit the scope and spirit of this disclosure.

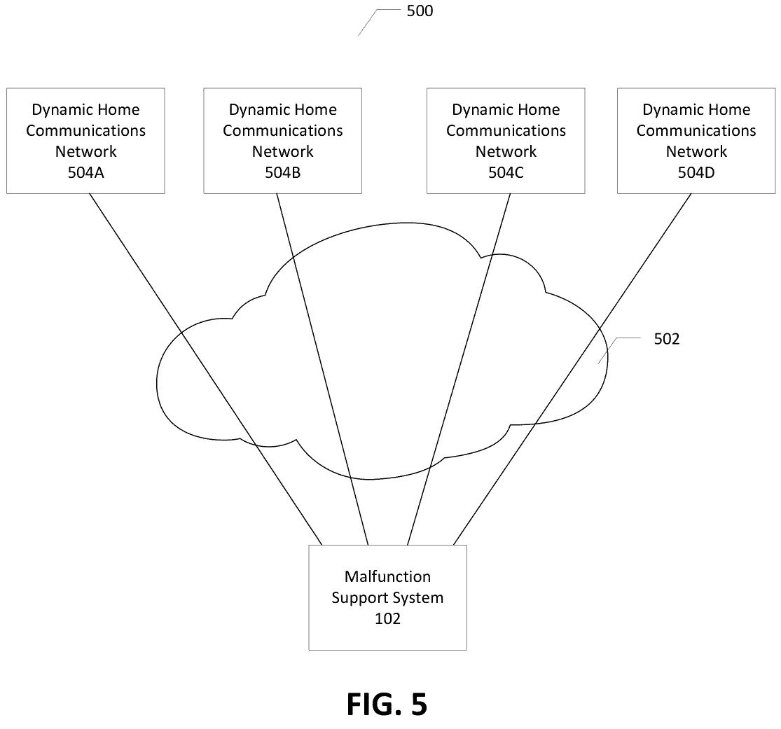

FIG. 5 is a schematic illustration of an example malfunction support system disposed in communication with various example dynamic home communication networks in accordance with embodiments of the present disclosure. Specifically, FIG. 5 depicts a visualization of an example system environment 500 including systems interacting to enable training for accurate predicted operational support data object selection and provision in accordance with the present disclosure. The example system environment 500 includes a plurality of dynamic home communications networks 504A, 504B, 504C, and 504D (collectively “dynamic home communications networks 504”), each associated with a malfunction support system 102. The malfunction support system 102 is communicable with some or all of each of the dynamic home communications networks 504 via a second communications network 502. In some embodiments, the malfunction support system 102 is embodied by the malfunction support apparatus 200 as depicted and described herein.

In some embodiments, each of the dynamic home communications networks 504 are embodied by any number of networked devices and/or include any number of connected networked devices. Any of such networked devices, or combinations of networked devices, may experience one or more malfunctions. Such dynamic home communications networks 504 may each include networked devices of different device types, a different topology of networked devices, a different number of networked devices, and/or the like. Additionally or alternatively, whether networked devices in one or more of the dynamic home communications networks 504 differ or are the same, such networked devices may nevertheless be configured differently, for example such that one or more configuration properties of two like networked devices are set to different values. It should be appreciated that such malfunctions may occur at any of a myriad of times and be caused by any of a myriad of underlying configurations, devices, and/or the like.

In some contexts, each of the dynamic home communications networks 504 is deployed in a distinct physical and/or virtual environment and/or location. For example, in some embodiments, each of the dynamic home communications networks 504 is deployed within a distinct home environment. In at least one example context, for example the dynamic home communications network 504A is embodied by networked devices within a home environment of a first user, the dynamic home communications network 504B is embodied by networked devices within a home environment of a second user, the dynamic home communications network 504C is embodied by networked devices within a home environment of a third user, and the dynamic home communications network 504D is embodied by networked devices within a home environment of a fourth user. The physical home environments in some contexts are proximate to one another (e.g., within a particular shared city, zip code, state, country, other region, and/or the like), or in some contexts are located far from one another or otherwise within distinct location designations. It should be appreciated that in some contexts, the dynamic home communications networks with which a malfunction support system 102 may be in any location and of any configuration, and thus unconstrained by physical location, network configuration, networked devices thereof, and/or the like, Such configurations enable a diverse range of dynamic home communications networks to be communicable with the malfunction support system 102.

The malfunction support system 102 may be communicable with the malfunction support system 102 over the second communications network 502. In some embodiments, the second communications network 502 embodies a public communications network, such as the Internet, that enables transmission of data between each of the dynamic home connections networks 504 and the malfunction support system 102. The dynamic home communications network 504A in some contexts each include at least one networked device that enables such communication with the malfunction support system 102. For example, in some embodiments, a client device of each of the dynamic home communications networks 504 executes one or more software application(s) that enables communication of data to and/or from the malfunction support system 102. The client device in some embodiments includes or embodies a user device (e.g., a specially configured smartphone device executing a software application associated with functionality of the malfunction support system 102), a specially configured network access point (e.g., a router or modem specially configured via software and/or firmware to provide data associated with networked devices on and/or embodying the dynamic home communications network), or a dedicated networked device (e.g., a computing device specially configured to monitor data associated with networked devices connected to and/or embodying a dynamic home communications network with which the computing device is connected). In this regard, in some embodiments the malfunction support system 102 communicates over the second communications network 502 with one or more computing devices associated with each of the dynamic home communications networks 504 to receive particular data associated with the networked devices thereof, for example device activity data, device identification data, and/or the like.

In some embodiments, the malfunction support system 102 receives one or more data sets from each of the dynamic home communications networks for use in training one or more data model(s). For example, the malfunction support system 102 in some embodiments receives one or more device activity data sets associated with each of the dynamic home communications networks 504, data indicating malfunction(s) experienced by networked device(s) of each of the dynamic home communications networks 504, device identification data sets indicating the networked devices and/or device types of networked devices on the dynamic home communications network, and/or the like. The malfunction support system 102 in some embodiments stores and/or otherwise maintains data sets including the data particular to each dynamic home communications network and the networked devices thereof. In this regard, in some such embodiments the malfunction support system 102 is configured to store and/or maintain historical activity data comprising the data portion(s) received for each of the dynamic home communications network. The resulting historical activity data may include, for each of the one or more dynamic home communications networks, historical device activity data, malfunction device history data for networked devices of each of the dynamic home communications networks, historical device identification data, and/or the like.

In some embodiments, the malfunction support system 102 trains a malfunction classification data model utilizing the stored data associated with the dynamic home communications networks 504. In some such embodiments, the malfunction classification data model is specially trained for a particular task associated with predicted operational support data object selection and/or provision. For example, in some embodiments, the malfunction support system 102 trains a malfunction classification data model to select a predicted operational support data object from a device operational support management repository that includes any number of operational support data objects available for selection. To select the predicted operational support data object, in some embodiments the malfunction classification data model is trained to identify device identification data corresponding to networked device(s) likely to experience or currently be experiencing a particular malfunction based on associated device activity data. The malfunction classification data model in some embodiments is further be trained to identify operational support data object(s) that are associated with or otherwise likely to assist in resolving the particular malfunction. In this regard, the malfunction support system 102 may train the malfunction classification data model to identify a particular malfunction classification identifier representing a particular malfunction affecting a communications network and/or particular networked device thereof, and identify the operational support data object determined most likely to assist in resolving the malfunction represented by the malfunction classification identifier.

In some embodiments, the malfunction support system 102 learns from aggregated data from several external systems, for example external dynamic home communications networks, to increase the amount of data available for use during training and/or improve the overall accuracy of determinations based on different data patterns identified from the aggregation of each of the individual data sets. For example, in some embodiments the malfunction classification data model learns data patterns, trends, and/or the like, that are indicative of particular malfunction(s) affecting particular networked device(s) from an external aggregated device activity data embodying aggregation of each of the individual device activity data sets for each of the dynamic home communications networks 504, and/or aggregation of other similar data sets associated with each of the dynamic home communications networks 504. Once a model is trained, in some embodiments the malfunction support system 102 stores the trained model for use, for example to actively select and output predicted operational support data object(s) associated with malfunction(s) affecting one or more networked device(s) and/or communications network(s).

In some embodiments, the malfunction support system 102 utilizes and/or communicates with a separate system that performs training of the one or more model(s), such as the malfunction classification data model, based on data received from one or more of the dynamic home communications networks 504. For example, in some embodiments, the malfunction support system 102 pushes data to one or more external system(s) that are configured to utilize the pushed data to train the one or more model(s) and return the trained model(s) to the malfunction support system 102. Such embodiments enable the malfunction support system 102 to reduce the amount of computing resources required to perform such training and increase the amount of computing resources available for servicing other tasks, for example determining malfunction(s) affecting or likely to affect one or more communications networks and/or selecting and outputting predicted operational support data objects associated with resolving such malfunction(s).

### Example Data Environment of the Disclosure

Having described example systems, apparatuses, data representations, and training methodologies of the disclosure, example data environments including visualizations of data elements and interactions between such data elements will now be described. It will be appreciated that the particular visualizations of data elements are exemplary, and that in some embodiments the data elements are actually embodied utilizing any of a myriad of data configurations, data types, value(s). In this regard, the particular visualizations of data elements and interactions between such data elements for non-limiting purposes of understanding and are not to limit the scope and spirit of the disclosure and the appended claims herein.

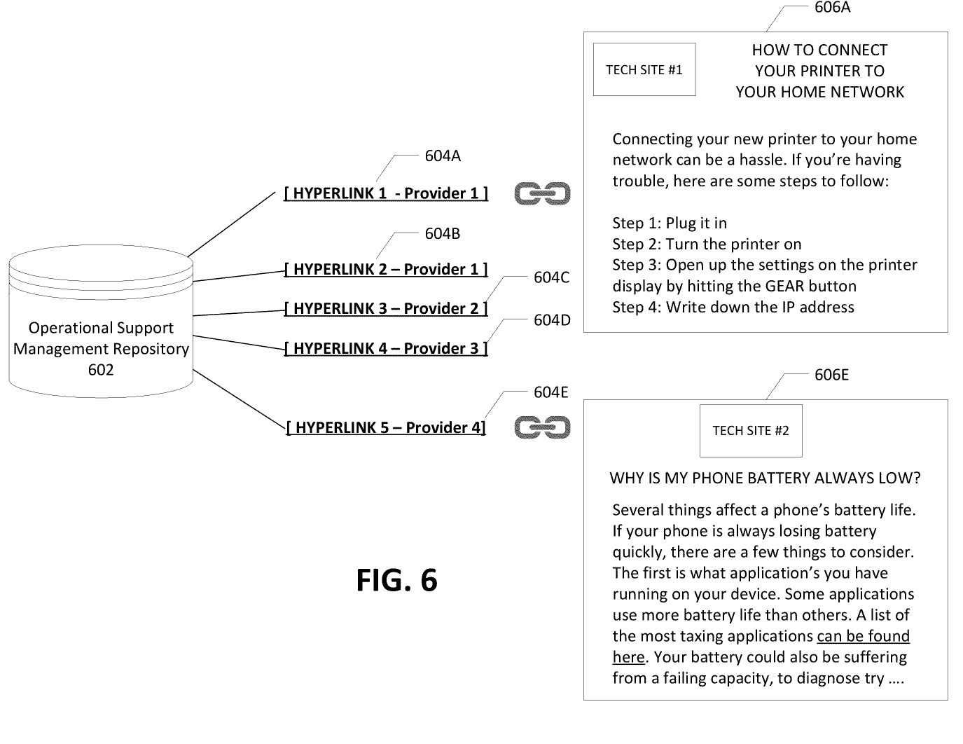

FIG. 6 illustrates an example data representation of operational support data objects storage within a system operational support management repository in accordance with at least some embodiments of the present disclosure. Specifically, FIG. 6 depicts a system operational support management repository 602 configured to store any number of operational support data objects, for example each of the operational support data objects 604A, 604B, 604C, 604D, and 604E (collectively “operational support data objects 604). In some embodiments, the system operational support management repository 602 is embodied by, included in, and/or otherwise maintained by a malfunction support apparatus 200. Additionally or alternatively, in some embodiments, the system operational support management repository 602 is embodied by, included in, and/or otherwise maintained by a separate device, system, and/or apparatus, and the malfunction support apparatus 200 is configured to access the system operational support management repository 602. For example, in some such embodiments, the system operational support management repository 602 is maintained separately to enable regular and/or continuous updates to the system operational support management repository 602 without affecting operation of the malfunction support apparatus 200 (e.g., addition of new operational support data object(s) stored to the repository, deletion of outdated, obsolete, and/or other marked operational support data object(s) previously stored to the repository, updating of operational support data object(s) stored to the repository, and/or the like).

The system operational support management repository 602 in some embodiments includes one or more computing devices embodied in hardware, software, firmware, and/or a combination thereof. For example, in some embodiments the system operational support management repository 602 includes one or more virtual database(s), physical database server(s), software-based storage solutions, and/or the like, that stores operational support data object(s). The system operational support management repository 602 may store any number of operational support data objects, for example each representing computer-executable instructions, software application(s), web-resource(s), and/or other content that assists in resolving one or more malfunction(s).

In some embodiments, the system operational support management repository 602 stores third-party malfunction support data objects. Each third-party operational support data object in some contexts embodies a data link (e.g., a URL, IP address, and/or the like) or other data-driven mechanism for accessing a data object stored by a device, system, and/or other computing device external to the system operational support management repository 602 and/or the malfunction support apparatus 200. In this regard, the third-party operational support data object in some embodiments enables access to the other data object stored by the external data system. Each third-party operational support data object in some contexts is maintained by a different external system and/or associated with a different provider entity that controls the data system storing the data object retrieved via the third-party operational support data object. For example, in some embodiments two different third-party operational support data objects are associated with the same provider entity, but accessible via different external systems associated with the same provider entity. Alternatively or additionally, in some embodiments two different third-party operational support data objects are associated with different provider entities and accessible via different external systems. Additionally or alternatively still, in some embodiments, the system operational support management repository 602 stores operational support data objects that do not require access via an external data system (e.g., files, internal links, and/or other resources having content stored in the system operational support management repository 602 embodied therein). In this regard, the system operational support management repository 602 advantageously provides a centralized mechanism for enabling access to operational support data object(s) regardless of whether the data corresponding to such operational support data objects are locally stored or externally maintained.

As illustrated, each of the operational support data objects 604 embodies a data link to a data object associated with resolving one or more malfunction(s). The various operational support data objects 604 are associated with various provider identifiers, specifically provider identifiers representing Providers 1, 2, 3, and 4. In some such embodiments, each of the providers maintains any number of systems for storing and/or otherwise making accessible data associated with one or more operational support data objects. In some embodiments, one or more of the provider identifiers corresponding to the entity that controls the system operational support management repository 602 and/or the malfunction support apparatus 200. Alternatively or additionally, in some embodiments, each of the provider identifiers corresponds to a third-party entity that controls one or more data systems external to the system operational support management repository 602 and/or malfunction support apparatus 200. As depicted, operational support data object 604A and operational support data object 604B are each associated with Provider 1, operational support data object 604C is associated with Provider 2, operational support data object 604D is associated with Provider 3, and operational support data object 604E is associated with Provider 4. In some embodiments, third party resources may be identified via a recommendation engine. In some embodiments, third party resources may be identified by generating structured data from a prior tech support use case indicating a link in the database that a particular resource may resolve an identified tech support use case.

The operational support data object 604A embodies a first third-party operational support data object associated with web content hosted by the Provider 1. For example, the third-party operational support data object embodies a web page 606A hosted by an external system controlled by Provider 1. The web page includes various content, including text content associated with connecting a printer to a home network. In this regard, in some contexts the third-party operational support data object stored to the system operational support management repository 602 embody the URL utilized to retrieve the web page from the external system hosting the web page.

The operational support data object 604E embodies a second third-party operational support data object associated with web content hosted by the Provider 4. For example, the third-party operational support data object embodies a web page 606B hosted by an external system controlled by Provider 4. The web page includes various content, including text content associated with determining why a computing device’s battery may consistently seem low powered. In this regard, it should be appreciated that in some embodiments the third-party operational support data object stored to the system operational support management repository 602 embodies the URL utilized to retrieve the web page from the external system hosting the web page. The operational support data object 604A may be outputted and utilized to access the corresponding data (e.g., the web page 606A) in circumstances where an identified malfunction classification identifier represents a printer system malfunction. Similarly, in some embodiments, the operational support data object 604E is outputted and utilized to access the corresponding data (e.g., web page 606B) in circumstances where an identified malfunction classification identifier represents a battery life system malfunction. For example, in some embodiments a malfunction classification data model is trained to identify the malfunction classification identifiers indicated by data associated with a particular set of device(s), communications network, and/or user profile (e.g., device activity data, support activity data, malfunction text description data, and/or the like).

In some embodiments, operational support data objects are stored linked to or otherwise associated with particular device identification data. For example, an operational support data object in some embodiments is linked to device identification data to indicate that the operational support data object assists in resolving a malfunction associated with that particular networked device, type of networked device, and/or the like. In some embodiments, such a link between an operational support data object and particular device identification data is generated manually (e.g., in response to user input upon determination that the operational support data object is associated with such particular device identification data) and/or automatically (e.g., in response to text, audio, and/or other algorithmic processing of the operational support data object to determine the particular device identification data with which said operational support data object should be linked). It will be appreciated that an operational support data object may be linked with any number of portions of device identification data. In some embodiments, the models described herein learn to predict the networked devices that are likely to be experiencing one or more malfunction(s), for example based on device identification data for networked devices and/or other data associated therewith such as device activity data and/or support activity data, and/or provide predicted operational support data object(s) determined most likely to be useful in resolving such malfunction(s).

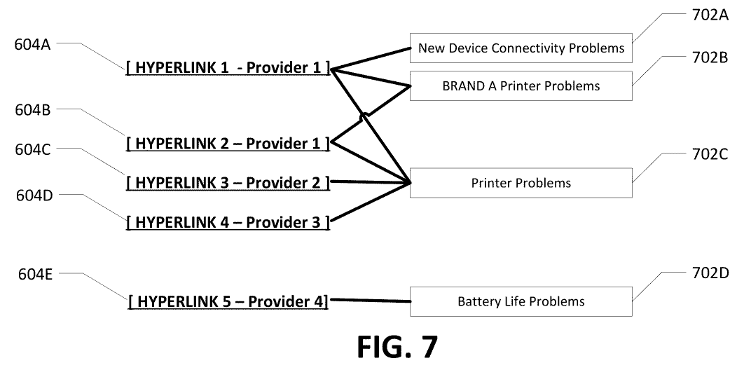

FIG. 7 illustrates an example data representation of operational support data objects associated with malfunction classification identifiers in accordance with at least some embodiments of the present disclosure. In some embodiments, the associations between malfunction classification identifiers and operational support data object(s) are maintained by the malfunction support apparatus 200. For example, in some embodiments, the associations between malfunction classification identifiers and operational support data object(s) are stored in a system operational support management repository. For example, in some contexts each operational support data object is embodied by one or more data record(s) stored in the system operational support management repository that include the malfunction classification identifier(s) with which the operational support data object is associated. Alternatively or additionally, in some embodiments, the associations between operational support data object(s) and malfunction classification identifier(s) is stored in one or more other repositories maintained by and/or accessible to the malfunction support apparatus 200.

Specifically, as depicted, FIG. 7 depicts associations between the operational support data objects 604 and various malfunction classification identifiers 702A, 702B, 702C, and 702D. The malfunction classification identifier 702A represents a classification of system events embodying malfunctions in connecting new devices to a communications network (e.g., a home network). The malfunction classification identifier 702B represents a classification of system events embodying malfunctions with operation of a printer having a make of Printer Brand A. The malfunction classification identifier 702C represents a classification of system events embodying malfunctions of a printer generally.

The malfunction classification identifier 702D represents a classification system events embodying malfunctions resulting in decreased device battery life. It should be appreciated that in some embodiments a first malfunction classification identifier represents a more detailed and/or narrowed classification of malfunction(s) represented by a second malfunction classification identifier. For example, “Printer Problems” may encompass all various malfunctions for various types, makes, and/or models of printer, and “BRAND A Printer Problems” may encompass a subset of such malfunctions specific to printers having a make of Printer Brand A. Similarly, a malfunction classification identifier of “BRAND A MODEL 1 Printer Problems” may encompass a subset of the malfunctions of the malfunction classification identifier “BRAND A Printer Problems,” specifically the malfunctions associated with the Model 1 of Brand A printer. Such example context malfunction classification identifiers are generated to represent any level of specificity and/or detail with respect to device characteristics, data properties, and/or the like. The malfunction classification identifier 702D represents a classification system events embodying malfunctions resulting in decreased device battery life.

In some embodiments, each association between an operational support data object and a malfunction classification identifier indicates the operational support data object assists in resolving one or more malfunction(s) represented by the malfunction classification identifier. For example, as depicted, operational support data object 604A is associated with malfunction classification identifier 702A, 702B, and 702C. In this regard, the association with malfunction classification identifier 702A indicates that the operational support data object 604A is helpful or otherwise may assist in resolving a malfunction involving connection of a new networked device, the association with malfunction classification identifier 702B indicates that the operational support data object 604A is helpful or may assist in resolving a malfunction involving a printer having a make of Brand A, and the association with malfunction classification identifier 702C indicates that the operational support data object 604A is helpful or may assist in resolving a malfunction involving a printer generally. Alternatively, operational support data object 604B is associated with malfunction classification identifier 702B and malfunction classification identifier 702C, indicating that the operational support data object 604B similarly is helpful or may assist in resolving a malfunction involving a printer having a make of Brand A and/or involving a printer generally, but not a malfunction involving connection of a new networked device (e.g., no association with malfunction classification identifier 702A is established).

Further still, operational support data objects 604C and 604D are each associated only with malfunction classification identifier 702C. In some contexts, such associations indicate that each of the operational support data objects 604C and 604D may assist in resolving a malfunction involving a printer generally, but not specific to a printer having a make of Brand A and/or resolving a malfunction involving connection of a new device. For example, operational support data object 604C may be associated with or otherwise include text data, software application(s), video content data, image content data, and/or the like, that assists in resolving malfunctions associated with a printer cartridge for an inkjet printer. Similarly, operational support data object 604D may be associated with or otherwise include text data, software application(s), video content data, image content data, and/or the like, that assists in resolving malfunctions associated with operation of a printhead for a thermal printer.

Finally, operational support data object 604E is associated only with malfunction classification identifier 702D. Such an association indicates that the operational support data object 604E may assist in resolving a malfunction involving a diminished battery life of a networked device. In this regard, the operational support data object 604E may not assist in resolving any malfunction represented by one or more of the other malfunction classification identifiers 702A, 702B, and/or 702C. For example, the operational support data object 604E may be associated with or otherwise include text data, software application(s), video content data, image content data, and/or the like, that assists in resolving malfunctions associated with degraded and/or otherwise diminished battery life (e.g., diagnosing hardware thermal fatigue issues, software applications draining significant battery life, and/or the like).

Some embodiments of the present disclosure generate such association(s) between an operational support data object and one or more malfunction classification identifier(s) manually and/or automatically based at least in part on processing of the operational support data object and/or malfunction classification identifier. For example, in some embodiments, a database administrator of the repository in which such associations are stored (e.g., a database administrator of the system operational support management repository) generates and/or stores such association(s) based on the content of the operational support data object. Alternatively or additionally, in some embodiments, the malfunction support apparatus 200 processes content, metadata, and/or any other data associated with the operational support data object to generate associations between the operational support data object and one or more malfunction classification identifier(s). For example, in some embodiments, the malfunction support apparatus 200 utilizes natural language processing to determine which malfunctions are discussed in content data for a particular operational support data object. In some such embodiments, the malfunction support apparatus 200 associates the operational support data object with malfunction classification identifier(s) that represent the malfunction(s) identified in such content data.

It will be appreciated that, in some embodiments, the operational support data objects are linked with various data identifiers indicating different aspects of the operational support data object. For example, in some embodiments, an operational support data object is linked with particular malfunction identifier(s) representing malfunction(s) the operational support data object may assist in resolving, device identification data that indicates the particular networked devices, type of networked devices, category of networked devices, and/or other grouping of networked devices that experience or are likely to experience the malfunction(s) the operational support data object may assist in resolving, and/or the like. In some such embodiments, an operational support data object is stored together with a composite identifier that includes one or more sub-portions indicating particular individual identifier(s) and/or sets of identifiers with which the operational support data object is associated. For example, in some embodiments, the operational support data object 604B is associated with one or more identifier(s), and/or a composite identifier, including an identifier for device identification data that uniquely identifies Printer Brand A printers, and a malfunction identifier that indicates printer problems (or a specific type of printer problem).

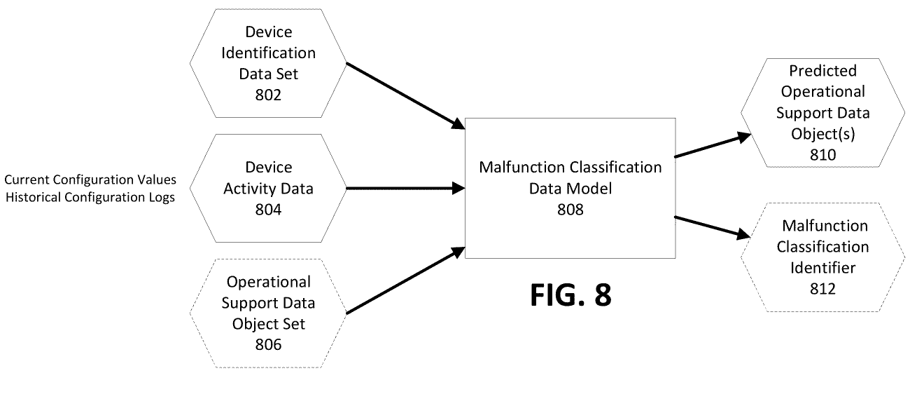

FIG. 8 illustrates an example visualization of predicted operational resource selection utilizing a malfunction classification data model in accordance with at least some embodiments of the present disclosure. Specifically, FIG. 8 depicts an example malfunction classification data model 808 that selects and/or outputs at least predicted operational support data object(s) 810 based on one or more portions of input data. In this regard, the malfunction support apparatus 200 in some embodiments maintains the malfunction classification data model 808 for selecting the predicted operational support data object(s) 810. The malfunction classification data model 808 may have been previously trained based on the particular type of input data to be utilized to select operational support data object(s).

The malfunction classification data model 808 in some contexts is embodied in any of a myriad of manners. For example, in some embodiments the malfunction classification data model 808 is embodied by one or more specially configured and/or trained algorithmic, statistical, and/or machine learning models, or a combination thereof. The malfunction classification data model 808 is configurable and/or trainable utilizing supervised learning and/or unsupervised learning. For example, in some embodiments, the malfunction classification data model 808 is embodied by one or more regression model(s), random forest model(s), KNN model(s), and/or the like. In some embodiments, the malfunction classification data model 808 is embodied by one or more k-means model(s), clustering model(s), and/or the like. In some embodiments, the malfunction classification data model 808 embodies an artificial intelligence specially configured to select the predicted operational support data object(s) 810 based at least in part on the input data.

In some embodiments, as illustrated, the malfunction classification data model 808 takes as input at least device identification data set 802. The device identification data set 802 in some embodiments includes device identification data for one or more networked device(s) connected to a particular communications network, previously connected to a particular communications network, and/or embodying at least a portion of the particular communications network, such as a dynamic home communications network. In this regard, in some contexts the device identification data set 802 indicates any number of networked devices that, at a given time, may be experiencing one or more malfunction(s). Additionally or alternatively, in some contexts the device identification data set 802 indicates any number of networked devices that, alone or in combination, contribute to one or more malfunction(s). The device identification data for each networked device in some embodiments is identified through direct communication with the networked device, retrieved from a data repository storing device identification data associated with the particular communications network, and/or retrieved from another networked device of the communications network that maintains device identification data associated with some or all networked devices on the communications network.

In some embodiments, as illustrated, the malfunction classification data model 808 takes as input at least device activity data set 804 as input. In some embodiments, the device activity data 804 includes various data received, requested, and/or otherwise detected for one or more networked device(s), communications network(s), and/or requesting client device(s) to be processed for providing predicted operational data object(s) associated with identified malfunction(s). For example, in some embodiments, the device activity data 804 includes various portions of device activity data, each associated with a networked device (or combination of networked devices) identified in the device identification data set 802.

In some embodiments, the device activity data 804 includes, without limitation, one or more current values for configuration properties of networked device(s). Alternatively or additionally, in some embodiments, the device activity data 804 includes historical data values for configuration properties of such networked device(s). Alternatively or additionally still, in some embodiments, the device activity data 804 includes indications of each change from historical data value(s) for particular configuration properties of such networked device(s). Alternatively or additionally still, in some embodiments, the device activity data 804 includes indications of connection(s) between a particular networked device and one or more other networked device(s), communication network(s), and/or the like. In this regard, it should be appreciated that the device activity data 804 may include any data relevant to identifying particular computing device(s), data characteristics of such computing device(s), connectivity of such computing device(s), and/or the like.

In some embodiments, the device activity data 804 is received from the malfunction support apparatus 200 for processing. In some embodiments, the device activity data 804 is received from a requesting client device that collects portions of the device activity data from each networked device communicable with the requesting client device over one or more communications networks at any number of time interval(s). Alternatively or additionally, in some embodiments, the malfunction support apparatus 200 requests the device activity data from a requesting client device and/or one or more networked device(s) directly. The malfunction support apparatus 200 in some embodiments requests the device activity data 804 upon initiation of a malfunction support session, at regular time intervals, upon receiving other input data (e.g., malfunction text description data), and/or the like. Alternatively or additionally still, in some embodiments, the malfunction support apparatus 200 detects the device activity data, for example by interrogating the networked device(s) on the communications network and/or processing communications transmitted over the communications network. For example, in some embodiments the malfunction support apparatus 200 process(es) transmission messages, networking packets, and/or other data communicated over a particular communications network to determine the device activity data 804 from the metadata and/or data therein.

Optionally in some embodiments, the malfunction classification data model 808 additionally or alternatively takes as input at least support activity data. In some embodiments, the support activity data includes various data associated with operations performed by a user for diagnosing and/or attempting resolution of one or more malfunction(s). Such support activity data may include, without limitation, support search data, malfunction text description data, previously accessed operational support data objects, and/or external query data performed via one or more networked device(s). In this regard, in some example contexts the support activity data includes various data relevant to particular support related actions performed by a user for diagnosing and/or attempting to resolve one or more malfunction(s).

In some embodiments, the support activity data is received by the malfunction support apparatus 200 for processing. For example, in some embodiments the support activity data is received from a requesting client device in response to request(s) by the malfunction support apparatus 200. In some embodiments, the malfunction support apparatus 200 requests the support activity data at particular time interval(s) and/or upon determination of particular event occurrence(s). For example, in some embodiments, the malfunction support apparatus 200 requests the support activity data from a requesting client device and/or associated networked device(s) in response to receiving data requesting and/or triggering initiation of a malfunction support session. Alternatively or additionally, in some embodiments, the malfunction support apparatus 200 receives and stores some or all of the support activity data as the requesting client device interacts with the malfunction support apparatus 200. For example, in some such embodiments, the malfunction support apparatus 200 receives and stores support activity data comprising malfunction text description data inputted via the requesting client device and/or an associated networked device during a main support process, such as a malfunction support session. Alternatively or additionally, in some embodiments for example, the malfunction support apparatus 200 receives and stores support search data via the requesting client device, indicating a user request to initiate a malfunction support session.

Additionally or alternatively still, optionally in some embodiments, the malfunction classification data model 808 takes as input at least an operational support data object set 806. In some embodiments, the operational support data object set 806 embodies or is included in a device operational support management repository. The operational support data object set 806 in some contexts embodies a set including any number of operational support data object(s) available for selection by the malfunction classification data model 808. In some embodiments, the malfunction support apparatus 200 retrieves the operational support data object set 806 from a system operational support management repository. The operational support data object set 806 in some embodiments includes all available operational support data objects, or in some embodiments includes a particular subset of available operational support data objects. For example, in some embodiments, a malfunction classification identifier is identified for processing via the malfunction classification data model 808, and the operational support data object set 806 includes the subset of available operational support data objects that are associated with the identified malfunction classification identifier.

In some embodiments, the malfunction classification data model 808 outputs predicted operational support data object(s) 810 based at least in part on the input data. The predicted operational support data object(s) 810 in some contexts embodies operational support data object(s) determined as sufficiently likely to assist in resolving a malfunction associated with an identified malfunction classification identifier. In this regard, the predicted operational support data object(s) 810 in some embodiments are each output to enable access to the operational support data object and/or content therein for use in attempting to resolve the malfunction (e.g., automatically or via user-initiated actions based at least in part on one or more of the predicted operational support data object(s) 810).

In some embodiments, the malfunction classification data model 808 generates a confidence score for one or more operational support data object(s) (e.g., each operational support data object of the operational support data object set 806). The confidence score for each operational support data object in some embodiments represents a likelihood that the operational support data object is associated with attempting to resolve a particular identified malfunction classification identifier. For example, in some embodiments, the malfunction classification data model 808 processes some or all of the input data (e.g., the device identification data set 802 and/or device activity data 804) to identify a malfunction classification identifier representing one or more malfunction(s) affecting networked device(s) communicable with and/or otherwise associated with a particular requesting client device. Alternatively or additionally, in some embodiments, the malfunction classification data model 808 receives the identified malfunction classification identifier as input. The generated confidence score for each operational support data objects thus in some contexts embodies the likelihood and/or confidence the malfunction support apparatus 200 has that the operational support data object will assist in resolving the malfunction(s) associated with the identified malfunction classification identifier.

In some embodiments, the malfunction classification data model 808 selects the predicted operational support data object(s) 810 based on the confidence score for each operational support data object. For example, in some embodiments, the malfunction classification data model 808 is configured to select and output a determinable number of predicted operational support data object(s) 810 that are associated with the highest confidence scores. For example, in some embodiments, the top 1, top 3, top 10%, and/or other determinable number of operational support data object(s) having the highest confidence scores are selected and/or output. Alternatively or additionally, in some embodiments, the malfunction classification data model 808 selects and/or outputs predicted operational support data object(s) 810 embodying all operational support data object(s) satisfying a particular minimum score threshold. In some such embodiments, any number of predicted operational support data object(s) are identifiable based on the scores (e.g., confidence scores) generated via the malfunction classification data model 808.

The predicted operational support data object(s) in some embodiments are utilized in any of a myriad of manners. In some embodiments, the malfunction support apparatus 200 outputs the predicted operational support data object(s) 810 to a requesting client device. The requesting client device in some such embodiments is caused to render the predicted operational support data object(s) 810 via a support user interface. In some such embodiments, a user of the requesting client device may analyze the predicted operational support data object(s) 810 rendered via the requesting client device and determine whether or not to interact with any of said predicted operational support data object(s). In a circumstance where one or more of the predicted operational support data object(s) 810 is interacted with, a main support process (e.g., a malfunction support session) is interrupted and/or terminated. Alternatively or additionally, in some embodiments, user input is received indicating one or more accessed data objects of the predicted operational support data object(s) 810 assisted in resolving one or more malfunction(s), and the malfunction support apparatus 200 terminates a main support process in response to receiving such an indication.

In some embodiments, the malfunction classification data model 808 outputs a malfunction classification identifier 812. The malfunction classification identifier 812 in some such embodiments represents one or more malfunction(s) associated with a requesting client device, networked devices communicable therewith, and/or a communications network. In some embodiments, the malfunction classification data model 808 is configured to select the malfunction classification identifier from one or more portions of the input data. For example, in some embodiments, the malfunction classification data model 808 is configured to select the malfunction classification identifier 812 based at least in part on the device identification data set 802 and/or the device activity data 804. In one such example context, the malfunction support apparatus 200 determines malfunction(s) indicated as affecting one or more networked devices based on the device activity data 804 (e.g., from malfunction text description data embodied therein), and in some embodiments identify the networked devices corresponding to such malfunction(s) based at least in part on the device activity data 804. In this regard, in some embodiments, the malfunction classification data model 808 scores each possible malfunction classification identifier and selects and outputs the malfunction classification identifier 812 associated with the highest score. The malfunction classification identifier 812 in some contexts is indicated as associated with one or more networked device(s), portions of device identification data, and/or the like.

In some embodiments, the malfunction classification data model identifies any number of malfunction classification identifiers, for example that satisfy a particular threshold or programmatically generate a score indicating a predetermined likelihood that the device is affected by a particular issue. In some embodiments, the malfunction classification data model 808 utilizes device activity data to determine a first set of malfunction classification identifiers, and identifies a particular malfunction classification identifier (e.g., the malfunction classification identifier 812) or a subset of the first set of malfunction classification identifiers that correspond to the most likely malfunction(s) (e.g., a highest score malfunction or tiered list of malfunctions based on the scoring of a list of potential issues) based at least in part on the support activity data. In this regard, the support activity data in some embodiments is utilized to narrow a particular set of malfunction classification identifiers into a subset of malfunction classification identifiers determined most likely to be affecting one mor more device(s), system(s), network(s), and/or the like.

It should be appreciated that, in other embodiments, the malfunction classification data model 808 includes one or more sub-models. For example, in some embodiments, the malfunction classification data model 808 comprises a first sub-model that is specially configured and/or trained to select the predicted operational support data object(s) 810 and a second sub-model that is specially configured and/or trained to select the malfunction classification identifier 812. Alternatively or additionally, in some embodiments, a second model separate from the malfunction classification data model 808 is specially configured and/or trained to select the malfunction classification identifier 812. In this regard, it will be appreciated that the malfunction classification data model 808 in some embodiments includes multiple, specially-trained sub-models or module(s) that are each trained for a particular task.

In some embodiments, the malfunction classification identifier 812 (and/or a set of malfunction classification identifiers having any number of malfunction classification identifiers) is utilized to select one or more operational support data object(s), as described herein. Alternatively or additionally, in some embodiments, the malfunction classification identifier 812 (and/or a set of malfunction classification identifiers) is outputted to a client device associated with a user. For example, in some embodiments, the malfunction classification identifier(s) is/are utilized to render one or more user interface element(s) that enables a user to select a particular malfunction associated with one or more of their devices from a limited list of such malfunction(s), as determined by the selected malfunction classification identifier(s). Alternatively or additionally, in some embodiments, the malfunction classification identifier(s) is/are utilized to render one or more user interface element(s) to a technician device (e.g., associated with a support technician to assist a user) that enables the support technician to select a particular malfunction the technician believes is affecting a user’s device(s) based on one or more portion(s) of data received associated with such malfunction(s). For example, in some embodiments, the support technician may have access to select a particular malfunction classification identifier determined to be likely affecting one more device(s) from the curated subset of possible malfunctions determined by the model of based on the device activity data and/or device support data.

### Example Processes of the Disclosure

Having described example systems, apparatuses, computing environments, interfaces, and data visualizations of the disclosure, example processes in accordance with the present disclosure will now be described. It will be appreciated that each of the flowcharts depicts an example computer-implemented process that is performable by one or more of the apparatuses, systems, devices, and/or computer program products described herein, for example utilizing one or more of the specially configured components thereof.

The blocks depicted indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

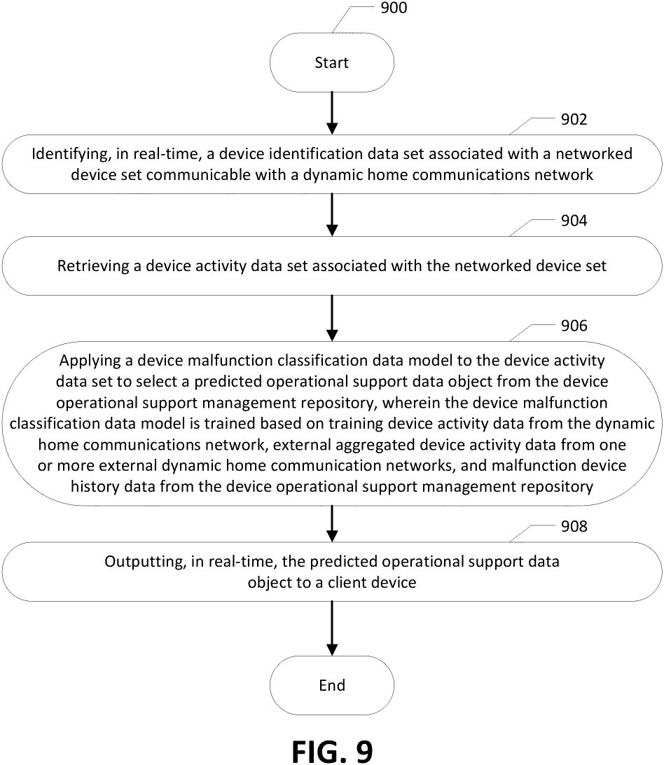

FIG. 9 illustrates a flowchart depicting example operations of an example process for selecting and outputting a predicted operational support data object in accordance with at least some example embodiments of the present disclosure. Specifically, FIG. 9 depicts operations of an example process 900. In some embodiments, the process 900 is embodied by computer program code stored on a non-transitory computer-readable storage medium of a computer program product configured for execution to perform the process as depicted and described. Alternatively or additionally, in some embodiments, the process 900 is performed by one or more specially configured computing devices, such as the malfunction support apparatus 200 alone or in communication with one or more other component(s), device(s), system(s), and/or the like. In this regard, in some such embodiments, the malfunction support apparatus 200 is specially configured by computer-coded instructions (e.g., computer program instructions) stored thereon, for example in the memory 204 and/or another component depicted and/or described herein and/or otherwise accessible to the malfunction support apparatus 200, for performing the operations as depicted and described. In some embodiments, the malfunction support apparatus 200 is in communication with one or more external apparatus(es), system(s), device(s), and/or the like, to perform one or more of the operations as depicted and described. For example, the malfunction support apparatus 200 in some embodiments is in communication with a client device and/or external data system. For purposes of simplifying the description, the process 900 is described as performed by and from the perspective of the malfunction support apparatus 200.

The process 900 begins at operation 902. At operation 902, the malfunction support apparatus 200 includes means, such as the support provision circuitry 210, the communications circuitry 208, the input/output circuitry 206, the processor 202, and/or the like, or a combination thereof, to identify, in real-time, a device identification data set associated with a networked device set communicable with a communications network, for example a dynamic home communications network. In some embodiments, the device identification data set is retrieved from a data repository that stores device identification data associated with networked device(s) of a particular communications network over a historical time period. Additionally or alternatively, in some embodiments, the malfunction support apparatus 200 interrogates the dynamic home communications network, and/or one or more individual networked devices thereof, to identify the device identification data set including device identification data for each networked device of the communications network. In some embodiments, a single networked device of the dynamic home communications network (for example, a network access point) maintains the device identification data set including device identification data for each networked device on the communications network, and the malfunction support apparatus 200 requests or otherwise interrogates the single networked device to identify the device identification data set. In yet some other embodiments, the malfunction support apparatus 200 is embodied as a part of the dynamic home communications network, such that the malfunction support apparatus 200 may identify, in real-time, the device identification data set by direct communication with each networked device of the dynamic home communications network and/or by collecting and storing device identification data for networked devices that connect to the communications network over a period of time.

At operation 904, the malfunction support apparatus 200 includes means, such as the support provision circuitry 210, the communications circuitry 208, the input/output circuitry 206, the processor 202, and/or the like, or a combination thereof, to retrieve a device activity data set associated with the networked device set. In some embodiments, the device activity data set is retrieved from one or more networked devices associated with the communications network to be processed, for example the dynamic home communications network. For example, in some embodiments, the malfunction support apparatus 200 retrieves device activity data associated with each networked device of the networked device set from each individual networked device with which the device activity data corresponds. Alternatively or additionally, in some embodiments, the malfunction support apparatus 200 retrieves the device activity data set from a particular networked device that detects, aggregates, and/or otherwise maintains device activity data corresponding to each of a plurality of networked devices. For example, in some embodiments a client device associated with the dynamic home communications network executes a specially configured software application that causes collection and/or storage of the device activity data for any number of networked devices on a particular communications network. The malfunction support apparatus 200 in some embodiments subsequently retrieves the device activity data set via communication with the client device that maintains such information. In some embodiments, the malfunction support apparatus 200 stores received device activity data associated with one or more networked device(s) in one or more repositories, for example in a device operational support management repository maintained by or otherwise accessible to the malfunction support apparatus 200. Alternatively or additionally, in some embodiments, the malfunction support apparatus 200 retrieves the device activity data set from the device operational support management repository for mode training and/or use.

At operation 906, the malfunction support apparatus 200 includes means, such as the support provision circuitry 210, the communications circuitry 208, the input/output circuitry 206, the processor 202, and/or the like, or a combination thereof, to apply a malfunction classification data model to the device activity data set to select a predicted operational support management repository. In some such embodiments, the malfunction classification data model is trained based on training data from the dynamic home communications network. In some embodiments, the training data includes previously collected device activity data specifically associated with the dynamic home communications network. In this regard, such data in some embodiments indicates data patterns particular to the specific dynamic home communications network. Additionally or alternatively, in some embodiments, the malfunction classification data model is trained based at least in part on external aggregated device activity data from one or more external dynamic home communications networks. The external aggregated device activity data in some embodiments includes any number of device activity data for networked devices of other, external dynamic home communications networks. Additionally or alternatively, in some embodiments, the malfunction classification data model is trained based at least in part on malfunction device history data from the device operational support management repository. The malfunction device history data in some embodiments indicates the particular malfunction classification identifier(s) for malfunction(s) affecting the networked devices of such dynamic home communications networks. In some embodiments, one or more of such data sets includes timestamp data and/or other identifiers that in some contexts is usable to link corresponding data in each of the data sets.

In some embodiments, the malfunction classification data model is configured to, or includes one or more sub-models configured to, perform one or more sub-determinations as part of selecting a predicted operational support data object. For example, in some embodiments, the malfunction classification data model (or a sub-model thereof) is configured to identify a malfunction classification identifier for malfunction(s) likely affecting and/or likely to affect the networked device(s) represented in a received device identification data set. Additionally or alternatively, in some embodiments, the malfunction classification data model (or a sub-model thereon) is configured to identify which operational support data objects of a possible set of operational support data objects are most likely to assist in resolving particular malfunction(s) being experienced and/or likely to be experienced. The malfunction classification data model, and/or various sub-models thereof, in some embodiments is/are trained based at least in part on the described training data, external aggregated device activity data, and/or malfunction device history data, to perform the various sub-determinations associated therewith based on the data patterns indicated in such portions of training data.

At operation 908, the malfunction support apparatus 200 includes means, such as the support provision circuitry 210, the communications circuitry 208, the input/output circuitry 206, the processor 202, and/or the like, or a combination thereof, to output, in real-time, the predicted operational support data object to a client device. In some embodiments, the malfunction support apparatus 200 transmits the predicted operational support data object to one or more requesting client device, via one or more data transmissions, upon request of predicted operational data object(s) received from the requesting client device. Alternatively or additionally, in some embodiments, the predicted operational support data object is outputted to a client device associated with the processed dynamic home communications network. The malfunction support apparatus 200 in some embodiments transmits the predicted operational support data object to cause the requesting client device to render, in real-time, a support user interface including at least an interface element associated with the predicted operational support data object. In this regard, in some embodiments the predicted operational support data object is rendered via the client device sufficiently quickly to enable the predicted operational support data object to be accessed during initiation of a particular software application associated with functionality of the malfunction support apparatus 200. Alternatively or additionally, in some embodiments, the malfunction support apparatus 200 transmits one or more messages to the client device for processing and/or display via a third-party application, such as an email communication, push notification, and/or the like.

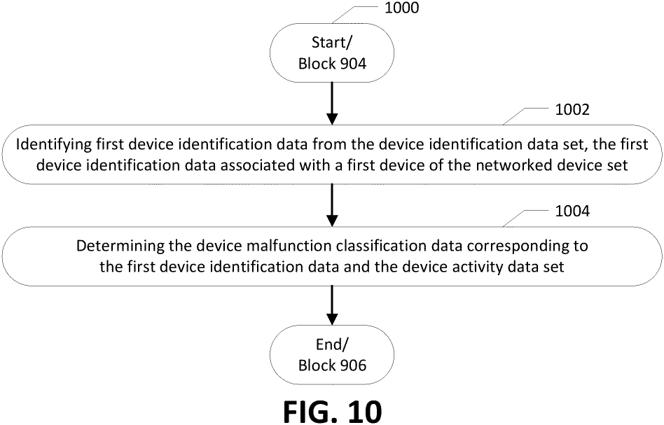

FIG. 10 illustrates a flowchart depicting example operations of an example process for determining malfunction classification data based at least in part on particular device identification data in accordance with at least some example embodiments of the present disclosure. Specifically, FIG. 10 depicts operations of an example process 1000. In some embodiments, the process 1000 is embodied by computer program code stored on a non-transitory computer-readable storage medium of a computer program product configured for execution to perform the process as depicted and described. Alternatively or additionally, in some embodiments, the process 1000 is performed by one or more specially configured computing devices, such as the malfunction support apparatus 200 alone or in communication with one or more other component(s), device(s), system(s), and/or the like. In this regard, in some such embodiments, the malfunction support apparatus 200 is specially configured by computer-coded instructions (e.g., computer program instructions) stored thereon, for example in the memory 204 and/or another component depicted and/or described herein and/or otherwise accessible to the malfunction support apparatus 200, for performing the operations as depicted and described. In some embodiments, the malfunction support apparatus 200 is in communication with one or more external apparatus(es), system(s), device(s), and/or the like, to perform one or more of the operations as depicted and described. For purposes of simplifying the description, the process 1000 is described as performed by and from the perspective of the malfunction support apparatus 200.

The process 1000 begins at operation 1002. In some embodiments, the process 1000 begins after one or more operations depicted and/or described with respect to any of the other processes described herein. For example, in some embodiments as depicted, the process 1000 begins after execution of operation 904. In this regard, some or all of the process 1000 may replace or supplement one or more blocks depicted and/or described with respect to any of the other processes described herein. Upon completion of the process 1000, the flow of operations may terminate. Additionally or alternatively, as depicted, upon completion of the process 1000, flow may return to one or more operations of another process, such as the operation 906. It should be appreciated that, in some embodiments, the process 1000 embodies a subprocess of one or more other process(es), such as the process 900.

At operation 1002, the malfunction support apparatus 200 includes means, such as the support provision circuitry 210, the communications circuitry 208, the input/output circuitry 206, the processor 202, and/or the like, or a combination thereof, to identify first device identification data from the device identification set. In some embodiments, the first device identification data is associated with a first device of the networked device set. In some embodiments, for example the malfunction support apparatus 200 iterates through each device identification data of the device identification data set, and processes each portion of device identification data individually and/or in combination with one or more other portions of device identification data to determine malfunction classification identifier(s) associated with the corresponding network device.

At operation 1004, the malfunction support apparatus 200 includes means, such as the support provision circuitry 210, the communications circuitry 208, the input/output circuitry 206, the processor 202, and/or the like, or a combination thereof, to determine malfunction classification data representing any number of malfunction classification identifier(s) corresponding to the first device identification data and the device activity data set. In some embodiments, the malfunction support apparatus 200 determines the malfunction identifier(s) associated with particular first device identification data and/or the device activity data set utilizing a specially trained data model. For example, in some embodiments, the malfunction support apparatus 200 determines the malfunction classification identifier(s) utilizing a specially trained malfunction classification data model, and/or a sub-model thereof. One or more malfunction classification identifier(s) in some embodiments are determinable based at least in part on the device activity data of the device activity data set that corresponds to the particular first device identification data. In this regard, in some such contexts such a portion of the device activity data set corresponding to the first device identification data is specifically processed to determine that the data values therein indicate a likelihood of an existing or future malfunction affecting the networked device, or being caused by the networked device, identified by the first device identification data. In one example context, for example, the malfunction support apparatus 200 determines a malfunction classification identifier indicating the networked device identified by the first device identification data is not configured for operation based on one or more data values corresponding to particular configuration properties indicated in the device activity data set.

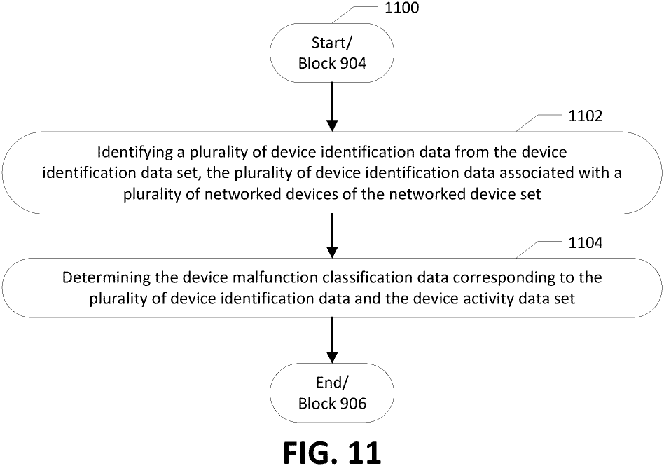

FIG. 11 illustrates a flowchart depicting example operations of an example process for determining malfunction classification data based at least in part on a plurality of device identification data in accordance with at least some example embodiments of the present disclosure. Specifically, FIG. 11 depicts operations of an example process 1100. In some embodiments, the process 1100 is embodied by computer program code stored on a non-transitory computer-readable storage medium of a computer program product configured for execution to perform the process as depicted and described. Alternatively or additionally, in some embodiments, the process 1100 is performed by one or more specially configured computing devices, such as the malfunction support apparatus 200 alone or in communication with one or more other component(s), device(s), system(s), and/or the like. In this regard, in some such embodiments, the malfunction support apparatus 200 is specially configured by computer-coded instructions (e.g., computer program instructions) stored thereon, for example in the memory 204 and/or another component depicted and/or described herein and/or otherwise accessible to the malfunction support apparatus 200, for performing the operations as depicted and described. In some embodiments, the malfunction support apparatus 200 is in communication with one or more external apparatus(es), system(s), device(s), and/or the like, to perform one or more of the operations as depicted and described. For purposes of simplifying the description, the process 1100 is described as performed by and from the perspective of the malfunction support apparatus 200.

The process 1100 begins at operation 1102. In some embodiments, the process 1100 begins after one or more operations depicted and/or described with respect to any of the other processes described herein. For example, in some embodiments as depicted, the process 1100 begins after execution of operation 904. In this regard, some or all of the process 1100 may replace or supplement one or more blocks depicted and/or described with respect to any of the other processes described herein. Upon completion of the process 1100, the flow of operations may terminate. Additionally or alternatively, as depicted, upon completion of the process 1100, flow may return to one or more operations of another process, for example the operation 906 as illustrated. It should be appreciated that, in some embodiments, the process 1100 embodies a subprocess of one or more other process(es), such as the process 900.

At operation 1102, the malfunction support apparatus 200 includes means, such as the support provision circuitry 210, the communications circuitry 208, the input/output circuitry 206, the processor 202, and/or the like, or a combination thereof, to identify a plurality of device identification data from the device identification data set. The plurality of device identification data in some embodiments is associated with a plurality of networked devices of a networked device set. In this regard, in some embodiments the plurality of identification data embodies a subset of device identification data corresponding to a particular subset of networked devices within a networked device set. In some embodiments, the plurality of device identification data is associated with a plurality of distinct networked devices. For example, in some embodiments, the malfunction support apparatus 200 identifies particular configurations and/or existence of a plurality of device identification data representing a particular grouping of networked devices. In this regard, the malfunction support apparatus 200 processes the device identification data set to determine whether such particular combinations of networked devices are represented in the device identification data set. Alternatively or additionally, in some embodiments, the malfunction support apparatus 200 utilizes one or more trained models, such as a malfunction classification data model, to identify a particular plurality of device identification data that corresponds to a particular combinations of networked devices (e.g., a combination of networked devices determined to contribute towards and/or otherwise cause a malfunction represented by a particular malfunction classification identifier).

At operation 1104, the malfunction support apparatus 200 includes means, such as the support provision circuitry 210, the communications circuitry 208, the input/output circuitry 206, the processor 202, and/or the like, or a combination thereof, to determine a malfunction classification identifier corresponding to the plurality of device identification data and the device activity data set. In some embodiments, the malfunction support apparatus 200 determines the malfunction identifier(s) associated with the plurality of device identification data and the device activity data set utilizing a specially trained data model. For example, in some embodiments, the malfunction support apparatus 200 determines the malfunction classification identifier(s) utilizing a specially trained malfunction classification data model, and/or a sub-model thereof. One or more malfunction classification identifier(s) in some contexts are determinable based at least in part on the device activity data of the device activity data set that corresponds to the particular networked devices identified by the plurality of device identification data. In this regard, such portions of the device activity data set corresponding to the plurality device identification data in some embodiments are specifically processed to determine that the data values therein indicate a likelihood of an existing or future malfunction affecting the networked device, or being caused by the networked device, identified by the first device identification data. In one example context, for example, the malfunction support apparatus 200 determines a malfunction classification identifier indicating the plurality of networked devices identified by the plurality of device identification data contribute to diminished operation of the communications network (e.g., diminished bandwidth allocation to one or more networked devices, and/or to networked devices connected to the dynamic home communications network generally) based at least in part on one or more data values corresponding to particular configuration properties indicated in the device activity data set corresponding to the plurality of device identification data.

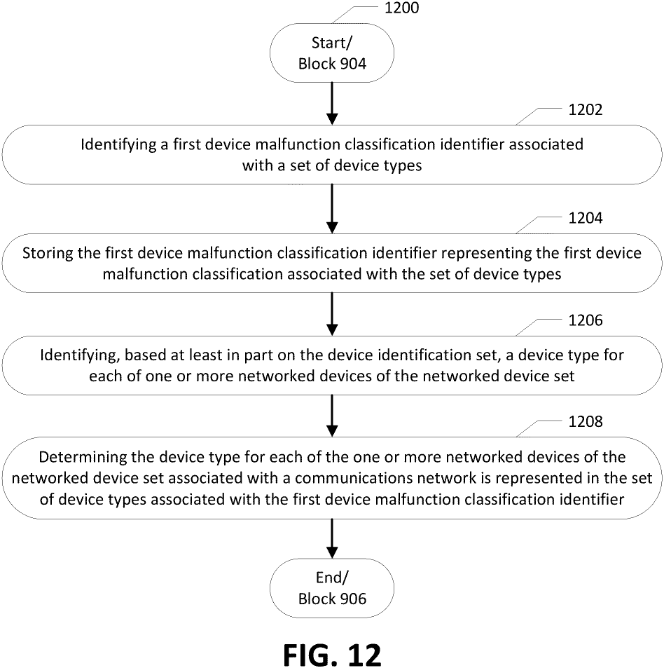

FIG. 12 illustrates a flowchart depicting example operations of an example process for determining malfunction classification data based on a set of device types in accordance with at least some example embodiments of the present disclosure. Specifically, FIG. 12 depicts operations of an example process 1200. In some embodiments, the process 1200 is embodied by computer program code stored on a non-transitory computer-readable storage medium of a computer program product configured for execution to perform the process as depicted and described. Alternatively or additionally, in some embodiments, the process 1200 is performed by one or more specially configured computing devices, such as the malfunction support apparatus 200 alone or in communication with one or more other component(s), device(s), system(s), and/or the like. In this regard, in some such embodiments, the malfunction support apparatus 200 is specially configured by computer-coded instructions (e.g., computer program instructions) stored thereon, for example in the memory 204 and/or another component depicted and/or described herein and/or otherwise accessible to the malfunction support apparatus 200, for performing the operations as depicted and described. In some embodiments, the malfunction support apparatus 200 is in communication with one or more external apparatus(es), system(s), device(s), and/or the like, to perform one or more of the operations as depicted and described. For purposes of simplifying the description, the process 1100 is described as performed by and from the perspective of the malfunction support apparatus 200.

The process 1200 begins at operation 1202. In some embodiments, the process 1200 begins after one or more operations depicted and/or described with respect to any of the other processes described herein. For example, in some embodiments as depicted, the process 1200 begins after execution of operation 904. In this regard, some or all of the process 1200 may replace or supplement one or more blocks depicted and/or described with respect to any of the other processes described herein. Upon completion of the process 1200, the flow of operations may terminate. Additionally or alternatively, as depicted, upon completion of the process 1200, flow may return to one or more operations of another process, for example the operation 906 as illustrated. It should be appreciated that, in some embodiments, the process 1200 embodies a subprocess of one or more other process(es), such as the process 900.

At operation 1202, the malfunction support apparatus 200 includes means, such as the support provision circuitry 210, the communications circuitry 208, the input/output circuitry 206, the processor 202, and/or the like, or a combination thereof, to identify a first malfunction classification identifier associated with a set of device types. The set of device types in some embodiments contributes to or otherwise causes the malfunction represented by the first malfunction classification identifier. In some embodiments, the malfunction support apparatus 200 identifies a particular malfunction is associated with the set of device types based on a particular rule set that indicates the device type(s) that contribute to or cause each malfunction associated with a malfunction classification identifier. Alternatively or additionally, in some embodiments, the malfunction support apparatus 200 identifies a particular malfunction is associated with the set of device types utilizing a particular trained data model. For example, in some embodiments, the malfunction support apparatus 200 identifies the first malfunction classification identifier is associated with a set of device types utilizing a malfunction classification data model trained to identify such correlations based on data patterns, trends, and/or other correlations extracted and/or learned from particular input training data, as described herein.

At operation 1204, the malfunction support apparatus 200 includes means, such as the support provision circuitry 210, the communications circuitry 208, the input/output circuitry 206, the processor 202, and/or the like, or a combination thereof, to store the first malfunction classification identifier representing the first malfunction classification associated with the set of device types. In some embodiments, the malfunction support apparatus 200 maintains a device operational support management repository storing particular data (e.g., malfunction device history data) that indicates the association between the first malfunction classification identifier and the set of device types. In this regard, in some embodiments the malfunction support apparatus 200 subsequently determines a likelihood the malfunction corresponding to the first malfunction classification identifier exist based at least in part on the existence of the set of device types and/or particular configurations thereof.

At operation 1206, the malfunction support apparatus 200 includes means, such as the support provision circuitry 210, the communications circuitry 208, the input/output circuitry 206, the processor 202, and/or the like, or a combination thereof, to identify, based at least in part on the device identification set, a device type for each of the one or more networked devices of the networked device set. For example, in some embodiments, the device type for each networked device is received as part of device activity data and/or device identification data associated with the networked device. Alternatively or additionally, in some embodiments, the malfunction support apparatus 200 identifies the device type based on the device identification data for a particular networked device. For example, in some embodiments the malfunction support apparatus 200 maintains and/or otherwise accesses a data repository that links device identifiers included in the device identification data with a particular device type.

At operation 1208, the malfunction support apparatus 200 includes means, such as the support provision circuitry 210, the communications circuitry 208, the input/output circuitry 206, the processor 202, and/or the like, or a combination thereof, to determine that the device type for each of the one or more networked devices of the networked device set representing a communications network, such as a dynamic home communications network, is represented in the set of device types associated with the first malfunction classification identifier. In this regard, the malfunction support apparatus 200 in some embodiments compares the device types for the networked devices of the networked device set with the set of device types associated with each first malfunction classification identifier. In a circumstance where the malfunction support apparatus 200 determines that the device types of a particular communications network are represented in the set of device types associated with a particular malfunction classification identifier, the malfunction support apparatus 200 in some embodiments determines that the malfunction represented by the malfunction classification identifier is likely or is affecting the communications network accordingly.

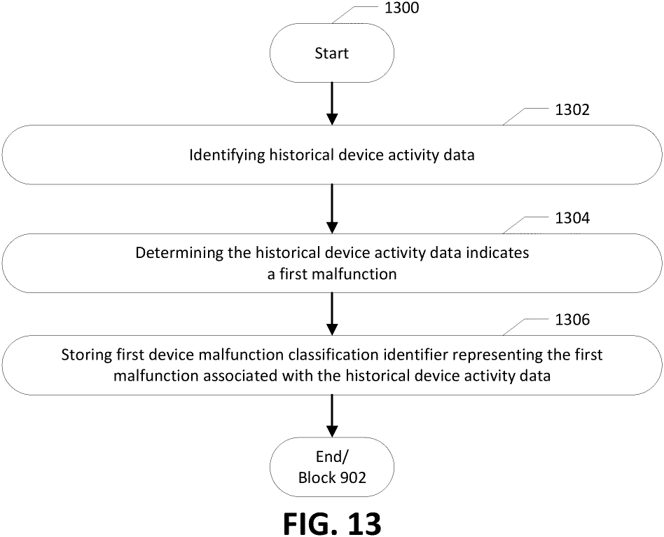

FIG. 13 illustrates a flowchart depicting example operations of an example process for storing malfunction classification data associated with one or more malfunction(s) in accordance with at least some example embodiments of the present disclosure. Specifically, FIG. 13 depicts operations of an example process 1300. In some embodiments, the process 1300 is embodied by computer program code stored on a non-transitory computer-readable storage medium of a computer program product configured for execution to perform the process as depicted and described. Alternatively or additionally, in some embodiments, the process 1300 is performed by one or more specially configured computing devices, such as the malfunction support apparatus 200 alone or in communication with one or more other component(s), device(s), system(s), and/or the like. In this regard, in some such embodiments, the malfunction support apparatus 200 is specially configured by computer-coded instructions (e.g., computer program instructions) stored thereon, for example in the memory 204 and/or another component depicted and/or described herein and/or otherwise accessible to the malfunction support apparatus 200, for performing the operations as depicted and described. In some embodiments, the malfunction support apparatus 200 is in communication with one or more external apparatus(es), system(s), device(s), and/or the like, to perform one or more of the operations as depicted and described. For purposes of simplifying the description, the process 1100 is described as performed by and from the perspective of the malfunction support apparatus 200.

The process 1300 begins at operation 1302. In some embodiments, the process 1300 begins after one or more operations depicted and/or described with respect to any of the other processes described herein. In this regard, in some embodiments some or all of the process 1300 replaces or supplements one or more blocks depicted and/or described with respect to any of the other processes described herein. Upon completion of the process 1300, the flow of operations may terminate. Additionally or alternatively, as depicted, upon completion of the process 1300, flow may return to one or more operations of another process, for example the operation 902 as illustrated. It should be appreciated that, in some embodiments, the process 1300 embodies a subprocess of one or more other process(es), such as the process 900.

At operation 1302, the malfunction support apparatus 200 includes means, such as the support provision circuitry 210, the communications circuitry 208, the input/output circuitry 206, the processor 202, and/or the like, or a combination thereof, to identify historical device activity data. In some embodiments, the historical device activity data is retrieved from one or more data repositories, such as a device operational support management repository maintained by the malfunction support apparatus 200. The historical device activity data in some embodiments is received and/or stored over a period of time, for example received by the malfunction support apparatus 200 at predetermined time intervals, upon submission by a user (e.g., in response to particular user input), upon occurrence of certain triggers (e.g., initiation of an authenticated session between a client device with the malfunction support apparatus 200), and/or the like. Alternatively or additionally, in some embodiments the malfunction support apparatus 200 identifies the historical device activity data from one or more third-party data repositories.

At operation 1304, the malfunction support apparatus 200 includes means, such as the support provision circuitry 210, the communications circuitry 208, the input/output circuitry 206, the processor 202, and/or the like, or a combination thereof, to determine the historical device activity data indicates a first malfunction. The historical device activity data may be processed to determine the particular portions of historical device activity data (e.g., particular data values for particular configuration properties) that contribute or otherwise causes a malfunction in one or more networked device(s) and/or in a network of device(s). In some embodiments, the malfunction support apparatus 200 identifies a particular malfunction is associated with particular portions of the historical device activity data based on a particular rule set that indicates the relevant portions of the historical device activity data that cause or otherwise contribute to the malfunction classification identifier. Alternatively or additionally, in some embodiments, the malfunction support apparatus 200 determines the first malfunction classification identifier is associated with particular portion(s) of the historical device activity data utilizing a data model, such as a malfunction classification data model, trained identify such correlations based on data patterns, trends, and/or other correlations extracted from the historical device activity data and/or particular input training data, as described herein. In one example context, the malfunction support apparatus 200 determines historical device activity data indicates a malfunction based on changes in the performance, operations, and/or functioning of one or more networked device(s) based on data indicating the operational performance of such networked device(s) (e.g., represented in or associated with the historical device activity data).

At operation 1306, the malfunction support apparatus 200 includes means, such as the support provision circuitry 210, the communications circuitry 208, the input/output circuitry 206, the processor 202, and/or the like, or a combination thereof, to store the first malfunction classification identifier associated with the historical device activity data. The malfunction classification identifier in some embodiments is generated to represent a newly determined malfunction. In this regard, in some embodiments the malfunction support apparatus 200 associates the historical device activity data together with the malfunction classification identifier to indicate that the historical device activity data contributes to or otherwise causes the first malfunction. In some embodiments, the stored association is represented by hyperparameters of a trained data model. Alternatively or additionally, in some embodiments, the first malfunction classification identifier is stored associated with the historical device activity data as malfunction device history data within a device operational support management repository. In this regard, in some embodiments such data is retrieved for use in subsequent training of one or more data model(s), for example a malfunction classification data model trained to select predicted operational support data object(s) associated with particular malfunction classification identifier(s).

### Conclusion

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

In some embodiments, some of the operations above may be modified or further amplified. Furthermore, in some embodiments, additional optional operations may be included. Modifications, amplifications, or additions to the operations above may be performed in any order and in any combination.

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Unless specifically defined herein, terms are used in a generic and descriptive sense only and not for purposes of limitation.

It will be appreciated that various example embodiments are described herein that provide technical advantages and solve technical problems particular to the complex nature of dynamic home communications networks. In other embodiments and contexts, similar advantages are provided to other types of communications networks (e.g., enterprise networks, and/or the like) without deviating from the innovative architectures and operations described throughout. Accordingly, in some embodiments, it will be appreciated that a communications network other than a dynamic home communications network may similarly be monitored and/or otherwise interacted with (e.g., by a malfunction support system) to provide similar advantages with respect to such non-dynamic home communications networks regardless of the reduction in complexity.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communications network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communications network. Examples of communications networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communications network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. An apparatus for using varied device activity data from a dynamic home communications network to select a predicted operational support data object from a device operational support management repository, the apparatus comprising at least one processor and at least one memory, the at least one memory having computer-coded instructions stored thereon that, in execution with the at least one processor, causes the apparatus to:
identify, in real-time, a device identification data set associated with a networked device set communicable with the dynamic home communications network;
retrieve a device activity data set associated with networked device set;
apply a malfunction classification data model to the device activity data set to select the predicted operational support data object from the device operational support management repository, wherein the malfunction classification data model is trained based on training data from the dynamic home communications network, external aggregated device activity data from one or more external dynamic home communications networks, and malfunction device history data from the device operational support management repository; and
output the predicted operational support data object to a client device in communication with the dynamic home communications network.

2. The apparatus according to claim 1, wherein the predicted operational support data object comprises a data link to a solution page associated with remediating malfunction classification data associated with the networked device set.

3. The apparatus according to claim 1, the apparatus further caused to determine malfunction classification data associated with the networked device set, wherein to determine the malfunction classification data, the apparatus is caused to:
identify first device identification data from the device identification set, the first device identification data associated with a first device of the networked device set; and
determine the malfunction classification data corresponding to the first identification data and the device activity data set.

4. The apparatus according to claim 1, the apparatus further caused to determine malfunction classification data associated with the networked device set, wherein to determine the malfunction classification data, the apparatus is caused to:
identify a plurality of device identification data from the device identification data set, the plurality of device identification data associated with a plurality of networked devices of the networked device set; and
determine the malfunction classification data corresponding to the plurality of device identification data and the device activity data set.

5. The apparatus according to claim 1, the apparatus further caused to determine malfunction classification data associated with the networked device set, wherein to determine the malfunction classification data, the apparatus is caused to:
determine the device activity data set indicates a first malfunction classification represented by the malfunction classification data.

6. The apparatus according to claim 1, wherein the device operational management repository comprises at least the predicted operational support data object associated with a set of device types and at least one malfunction classification identifier in malfunction classification data associated with the networked device set, and wherein the device identification data set indicates the networked device set comprises one or more networked devices of the set of device types.

7. The apparatus according to claim 1, the apparatus further caused to:
identify a first malfunction classification associated with a set of device types; and
store first malfunction classification data representing the first malfunction classification associated with the set of device types,
determine malfunction classification data associated with networked device set associated with the networked device set, wherein to determine the malfunction classification data the apparatus is further caused to:
identify, based at least in part on the device identification set, a device type for each of one or more networked devices of the networked device set; and
determine the set of device types associated with the first malfunction classification data includes the device type for each of the one or more networked devices of the networked device set.

8. The apparatus according to claim 1, the apparatus further caused to:
identify historical activity data;
determine the historical activity data indicates a first malfunction; and
store a first malfunction classification identifier representing the first malfunction associated with the historical activity data.

9. A computer-implemented method of using varied device activity data from a dynamic home communications network to select a predicted operational support data object from a device operational support management repository, the computer-implemented method comprising:
identifying, in real-time, a device identification data set associated with a networked device set communicable with the dynamic home communications network;
retrieving a device activity data set associated with networked device set;
applying a malfunction classification data model to the device activity data set to select the predicted operational support data object from the device operational support management repository, wherein the malfunction classification data model is trained based on training data from the dynamic home communications network, external aggregated device activity data from one or more external dynamic home communications networks, and malfunction device history data from the device operational support management repository; and
outputting the predicted operational support data object to a client device in communication with the dynamic home communications network.

10. The computer-implemented method according to claim 9, wherein the predicted operational support data object comprises a data link to a solution page associated with remediating malfunction classification data associated with the networked device set.

11. The computer-implemented method according to claim 9, the computer-implemented method further comprising determining malfunction classification data associated with the networked device set by at least:
identifying first device identification data from the device identification set, the first device identification data associated with a first device of the networked device set; and
determining the malfunction classification data corresponding to the first identification data and the device activity data set.

12. The computer-implemented method according to claim 9, the computer-implemented method further comprising determining malfunction classification data associated with the networked device set by at least:
identifying a plurality of device identification data from the device identification data set, the plurality of device identification data associated with a plurality of networked devices of the networked device set; and
determining the malfunction classification data corresponding to the plurality of device identification data and the device activity data set.

13. The computer-implemented method according to claim 9, the computer-implemented method further comprising determining malfunction classification data associated with the networked device set by at least:
determining the device activity data set indicates a first malfunction classification represented by the malfunction classification data.

14. The computer-implemented method according to claim 9, wherein the device operational management repository comprises at least the predicted operational support data object associated with a set of device types and at least one malfunction classification identifier in malfunction classification data associated with the networked device set, and wherein the device identification data set indicates the networked device set comprises one or more networked devices of the set of device types.

15. The computer-implemented method according to claim 9, the computer-implemented method further comprising:
identifying a first malfunction classification associated with a set of device types; and
storing first malfunction classification data representing the first malfunction classification associated with the set of device types; and
determining malfunction classification data associated with the networked device set associated with the networked device set by at least:
identifying, based at least in part on the device identification set, a device type for each of one or more networked devices of the networked device set; and
determining the set of device types associated with the first malfunction classification data includes the device type for each of the one or more networked devices of the networked device set.

16. The computer-implemented method according to claim 9, the computer-implemented method further comprising:
identifying historical activity data;
determining the historical activity data indicates a first malfunction; and
storing a first malfunction classification identifier representing the first malfunction associated with the historical activity data.

17. A computer program product of using varied device activity data from a dynamic home communications network to select a predicted operational support data object from a device operational support management repository, the computer program product comprising at least one non-transitory computer-readable storage medium having computer program code stored thereon that, in execution with at least one processor, configures the computer program product for:
identifying, in real-time, a device identification data set associated with a networked device set communicable with the dynamic home communications network;
retrieving a device activity data set associated with networked device set;
applying a malfunction classification data model to the device activity data set to select the predicted operational support data object from the device operational support management repository, wherein the malfunction classification data model is trained based on training data from the dynamic home communications network, external aggregated device activity data from one or more external dynamic home communications networks, and malfunction device history data from the device operational support management repository; and
outputting the predicted operational support data object to a client device in communication with the dynamic home communications network.

18. The computer program product according to claim 17, wherein the predicted operational support data object comprises a data link to a solution page associated with remediating malfunction classification data associated with the networked device set.

19. The computer program product according to claim 17, the computer program product further configured for:
identifying a first malfunction classification associated with a set of device types; and
storing first malfunction classification data representing the first malfunction classification associated with the set of device types; and
determining malfunction classification data associated with the networked device set by at least:
identifying, based at least in part on the device identification set, a device type for each of one or more networked devices of the networked device set; and
determining the set of device types associated with the first malfunction classification data includes the device type for each of the one or more networked devices of the networked device set.

20. The computer program product according to claim 17, the computer program product further configured for:
identifying historical activity data;
determining the historical activity data indicates a first malfunction; and
storing a first malfunction classification identifier representing the first malfunction associated with the historical activity data.
